(19) United States
(12) Patent Application Publication
(10) Pub. No.: US 2024/0232712 A1
(43) Pub. Date: Jul. 11, 2024

(54) MACHINE LEARNING ARCHITECTURE FOR DETECTING EARLY ADOPTERS

(71) Applicant: ZS Associates, Inc., Evanston, IL (US)

(72) Inventors: Asheesh Shukla, Lower Gwynedd, PA (US); Albert Whangbo, Durham, NC (US); Siddharth Kumar, Robbinsville, NJ (US); Wenhao Xia, Evanston, IL (US); Saswat Sahu, Lawrenceville, NJ (US); Prabisha Mallick, Bangalore (IN); Adnan Patel, Yardley, PA (US)

(73) Assignee: ZS Associates, Inc., Evanston, IL (US)

(21) Appl. No.: 18/407,056

(22) Filed: Jan. 8, 2024

Related U.S. Application Data
(60) Provisional application No. 63/437,922, filed on Jan. 9, 2023.

(51) Int. Cl. G06N 20/00

(52) U.S. Cl. CPC G06N 20/00

(57) ABSTRACT

Disclosed herein are methods and systems for implementing a machine learning architecture for detecting early adopters. A method includes receiving clinical data; training, using a supervised or unsupervised learning technique, a machine learning model (e.g., a neural network, a support vector machine, or a random forest) to generate a score identifying a likelihood to prescribe a medical product; generating, by the machine learning model, a score indicating a likelihood of a first medical personnel to prescribe a type of medical product within a defined time period; and causing a display at a client device based on the score.

### CROSS-REFERENCE TO RELATED APPLICATIONS

This application claims the benefit of priority to U.S. Provisional Patent Application, 63/437,922, filed Jan. 9, 2023, the entirety of which is incorporated by reference herein.

### TECHNICAL FIELD

This application relates generally to implementing a machine learning architecture for detecting early adopters of medical products.

### BACKGROUND

Identifying early adopters of medical products (e.g., medical personnel that prescribe medical products soon after launch) is a historically analogue process. For example, conventionally, a company may seek to identify individuals that are likely to prescribe certain medical products, such as medications, based on word of mouth or by analyzing publications the individuals wrote. Doing so may require desk research, which can be time-consuming and inefficient. The company may not be able to accurately identify factors that contribute to whether an individual is likely to be an early adopter of a newly launched medical product. In some cases, a company may not be able to access such data or may not have the knowledge to collect the relevant data to make such determinations. This difficulty may be compounded when companies collect data for medical personnel online. Such companies may obtain a large amount of data that is difficult to filter through and/or determine what is relevant. Explicit statements by the medical personnel that they are early adopters may be rare and/or not available in online data.

### SUMMARY

For the aforementioned reasons, there is a need to take advantage of the breadth of information that is transmitted over the Internet and between different types of data sources (e.g., publicly available data sources, medical data sources, medical data sources combined with desk research and/or human intelligence, etc.) to identify early adopters of medical products. More specifically, data that is available to help identify medical personnel that are early adopters over the Internet may not include any explicit statements that the medical personnel are early adopters. There is a need to develop computer-implemented models (e.g., machine learning and/or optimization models) that can automatically identify early adopters in general and/or for specific types of medical products from the available online data.

A system implementing the systems and methods described herein may overcome the aforementioned technical deficiencies. For example, the system (e.g., a processor of the system) may provide and/or train a computer model (e.g., a machine learning model) to generate scores for individual medical personnel. The scores may indicate a likelihood of the medical personnel to prescribe a medical product of a specific type within a defined time period relative to a launch of the medical product. The system may train the computer model based on clinical data regarding the medical personnel the system collects from various data sources. The system may identify timestamps from the clinical data indicating times of launches of medical products and prescriptions for the medical products. The system may identify types of the medical products. The system may determine differences between the prescriptions and the launches of the medical products and train the computer model based on the determined differences. The system may train the computer model to determine scores for the different types of medical products by including identifiers of the types of the medical products in the training data. Responsive to being sufficiently trained, the system may implement the computer model to output scores for different medical personnel indicating the likelihoods that the respective medical personnel would prescribe particular medical products.

The system may use the computer model to respond to requests from client devices. For example, a client device may transmit a request for identifications of medical personnel that would likely be early adopters of a medical product. The client device may include an identification of a type of the medical product in the request. A processor of the system may receive the request and execute the trained computer model using an identification of the type of medical product and clinical data of different medical personnel as input. The computer model may output scores indicating likelihoods that the different medical personnel would be early adopters of a medical product of the requested type. The processor may generate a ranked list of the medical personnel based on the respective scores. The processor may transmit the ranked list to the requesting client device and/or transmit a number of medical personnel ranked the highest (e.g., as requested by the client device). The client device may display the received scores and/or identifications of the medical personnel on a display or user interface.

In some cases, in addition to generating early adopter scores and/or identifying early adopters, the processor may execute one or more other models (e.g., machine learning models or analytical models) to calculate other metrics for medical personnel. The processor may do so using the clinical data the processor retrieves from different data sources. The processor may generate medical personnel profiles from the metrics, including the early adopter scores, by inserting the metrics in the profiles of the medical personnel profiles. The processor may transmit such profiles and/or metrics stored in the profiles to client devices upon receipt of requests. In this way, the processor may provide client devices with a view of different medical personnel according to clinical data the processor retrieves from various data sources.

Advantageously, by using machine learning techniques and/or other computer models to calculate metrics for medical personnel, the system may parse through a large amount of data that is available from different data sources (e.g., online data sources). The system may do so to identify early adopters and/or other characteristics regarding the medical personnel. The system may both train the models and use the models using the data to generate the metrics, increasing the accuracy of the models and/or enabling the models to use a large variety of data to generate the metrics.

In an embodiment, a method comprises receiving, by a processor from a plurality of data sources, clinical data for a plurality of medical personnel, the clinical data identifying a timing of one or more prescriptions of each of the plurality of medical personnel relative to a launch of a type of medical product; training, by the processor, using machine learning applied to the clinical data, a model configured to receive as input clinical data of a medical personnel and a type of medical product and provide as output a score identifying a likelihood of the medical personnel to prescribe a medical product of the type of medical product within a defined time period relative to a launch of a medical product; providing, by the processor, clinical data of a first medical personnel and a first type of medical product to the model; receiving, by the processor from the model, a score indicating a likelihood of the first medical personnel to prescribe the first type of medical product within the defined time period relative to a launch of the first type of medical product; and causing, by the processor, a display at a client device based on the score.

In another embodiment, a system comprises a server comprising a processor and a non-transitory computer-readable medium. The non-transitory computer-readable medium may contain instructions that when executed by the processor causes the processor to perform operations comprising receiving, from a plurality of data sources, clinical data for a plurality of medical personnel, the clinical data identifying a timing of one or more prescriptions of each of the plurality of medical personnel relative to a launch of a type of medical product; training using machine learning applied to the clinical data, a model configured to receive as input clinical data of a medical personnel and a type of medical product and provide as output a score identifying a likelihood of the medical personnel to prescribe a medical product of the type of medical product within a defined time period relative to a launch of a medical product; providing clinical data of a first medical personnel and a first type of medical product to the model; receiving, from the model, a score indicating a likelihood of the first medical personnel to prescribe the first type of medical product within the defined time period relative to a launch of the first type of medical product; and causing a display at a client device based on the score.

In another embodiment, a method for training a model for medical product early adopter prediction comprises receiving, by a processor and from a plurality of data sources, clinical data for a plurality of medical personnel, the clinical data identifying a timing of one or more prescriptions of each of the plurality of medical personnel relative to a launch of the medical product; identifying, by the processor and from the clinical data, a timestamp of the launch of the medical product and a timestamp of each of the one or more prescriptions for the medical product by each of the plurality of medical personnel; determining, by the processor, one or more differences between the timestamp of the launch of the medical product and one or more timestamps of the one or more prescriptions; generating, by the processor, a training data set according to the one or more differences; and training, by the processor, the model with the training data set using machine learning.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which reference numerals identify similar or identical elements. Reference numerals that are introduced in the specification in association with a drawing figure may be repeated in one or more subsequent figures without additional description in the specification to provide context for other features, and not every element may be labeled in every figure. The drawing figures are not necessarily to scale, emphasis instead being placed upon illustrating embodiments, principles, and concepts. The drawings are not intended to limit the scope of the claims included herewith.

FIG. 1A is a block diagram of embodiments of a computing device;

FIG. 1B is a block diagram depicting a computing environment comprising client devices in communication with cloud service providers;

FIG. 2 is a block diagram of an example system in which profile generation services may manage and streamline access by clients to resource feeds (via one or more gateway services) and/or software-as-a-service (SaaS) applications;

FIG. 3 is an example computing environment for implementing a machine learning architecture for early adopter prediction, in accordance with one or more implementations;

FIG. 4A illustrates a flowchart of an example method for implementing a machine learning architecture for early adopter prediction, in accordance with one or more implementations;

FIG. 4B-4F illustrates different assumptions and/or operations the data processing system can use to determine different metrics for a medical personnel, in accordance with one or more implementations;

FIG. 5 illustrates a flowchart of an example method for training a machine learning model for early adopter prediction, in accordance with one or more implementations;

FIG. 6 illustrates a sequence for implementing a machine learning architecture for early adopter prediction, in accordance with one or more implementations;

FIG. 7 illustrates another sequence for implementing a machine learning architecture for early adopter prediction, in accordance with one or more implementations; and

FIGS. 8-44 illustrate non-limiting examples of graphical user interfaces of an electronic platform enabling users to request and view details regarding medical personnel, in accordance with one or more implementations.

The features and advantages of the present solution will become more apparent from the detailed description set forth below when taken in conjunction with the drawings, in which like reference characters identify corresponding elements throughout. In the drawings, reference numbers generally indicate identical, functionally similar, and/or structurally similar elements.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

Section A describes a computing environment that may be useful for practicing embodiments described herein;

Section B describes a non-limiting example of a machine learning architecture for early adopter prediction; and

Section C describes a non-limiting example of a method for implementing a machine learning architecture for early adopter prediction.

### Section A: Computing Environment

Prior to discussing the specifics of embodiments of the systems and methods of an appliance and/or client, it may be helpful to discuss the computing environments in which such embodiments may be deployed.

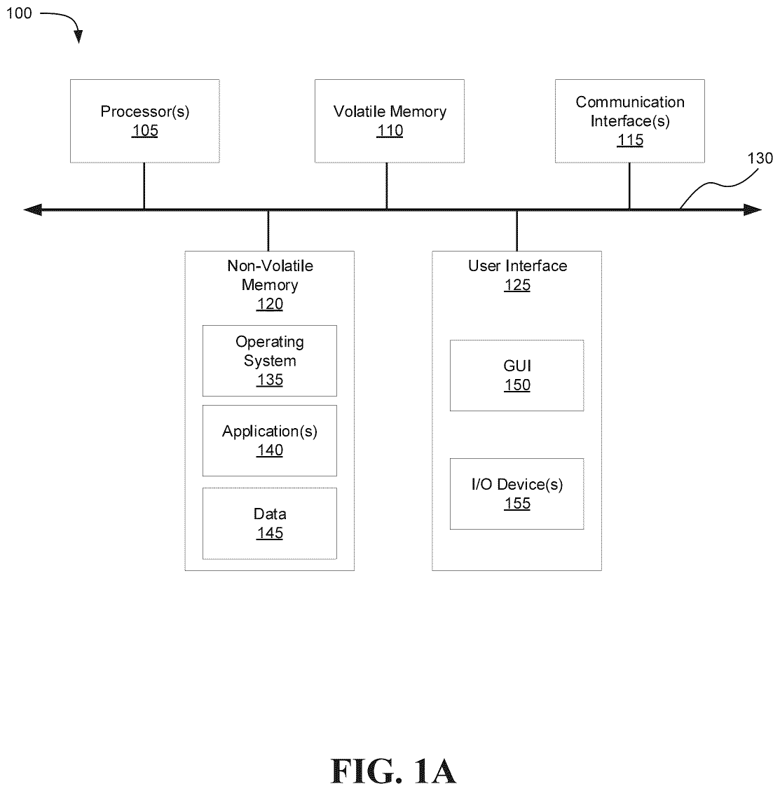

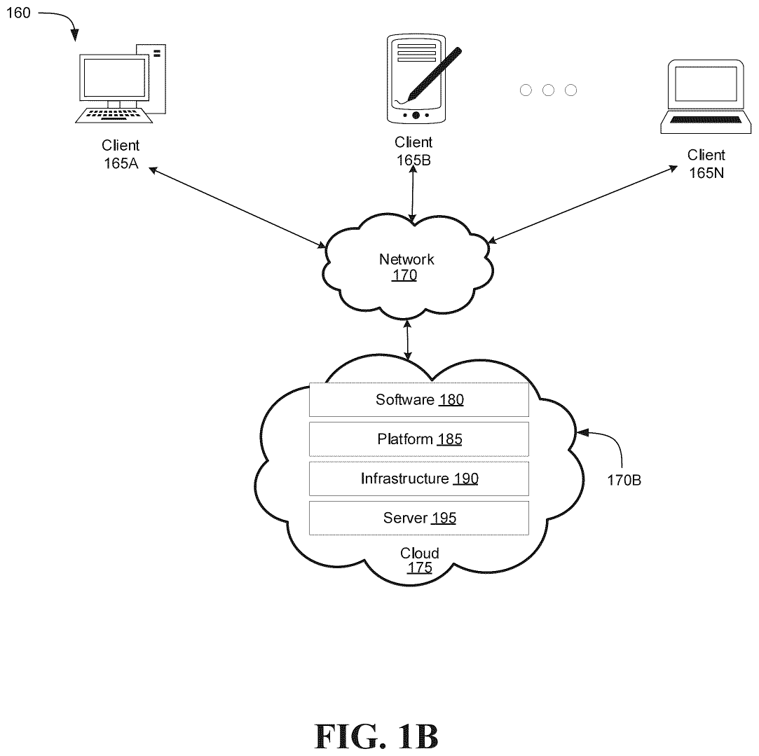

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid-state drives (SSDs) such as a flash drive or other solid-state storage media, one or more hybrid magnetic and solid-state drives, and/or one or more virtual storage volumes, such as cloud storage, or a combination of such physical storage volumes and virtual storage volumes or arrays thereof), a user interface (UI) 125, one or more communications interfaces 115, and a communication bus 130. User interface 125 may include a graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). The non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than the main memory. Data may be entered using an input device of GUI 150 or received from I/O device(s) 155. Various elements of computer 100 may communicate via one or more communication buses, shown as communication bus 130.

The computer 100 as shown in FIG. 1A is shown merely as an example, as clients, servers, intermediary, and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hardcoded into the circuitry or soft coded by way of instructions held in a memory device and executed by the circuitry.

A “processor” may perform the function, operation, or sequence of operations using digital values and/or using analog signals. In some embodiments, the “processor” can be embodied in one or more application-specific integrated circuits (ASICs), microprocessors, digital signal processors (DSPs), graphics processing units (GPUs), microcontrollers, field-programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors may provide functionality for parallel, simultaneous execution of instructions, or for parallel, simultaneous execution of one instruction on more than one piece of data.

Communications interfaces 115 may include one or more interfaces to enable the computer 100 to access a computer network such as a Local Area Network (LAN), a Wide Area Network (WAN), a Personal Area Network (PAN), or the Internet through a variety of wired and/or wireless or cellular connections.

In described embodiments, the computer 100 may execute an application on behalf of a user of a client computer. For example, the computer 100 may execute a virtual machine, which provides an execution session within which applications execute on behalf of a user or a client computer, such as a hosted desktop session. The computer 100 may also execute a terminal services session to provide a hosted desktop environment. The computer 100 may provide access to a computing environment including one or more of one or more applications, one or more desktop applications, and one or more desktop sessions in which one or more applications may execute.

Referring to FIG. 1B, a computing environment 160 is depicted. Computing environment 160 may generally be implemented as a cloud computing environment, an on-premises (“on-prem”) computing environment, or a hybrid computing environment including one or more on-prem computing environments and one or more cloud computing environments. When implemented as a cloud computing environment, also referred to as a cloud environment, cloud computing, or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include but are not limited to, networks, network bandwidth, servers, processing, memory, storage, applications, virtual machines, databases, software, hardware, analytics, and intelligence.

In some embodiments, the computing environment 160 may provide client 165 with one or more resources provided by a network environment. The computing environment 160 may include one or more clients 165a-165n, in communication with a cloud 175 over one or more networks 170. Clients 165 may include, e.g., thick clients, thin clients, and zero clients. The cloud 108 may include back-end platforms, e.g., servers, storage, server farms, or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In some embodiments, the computing environment 160 can include a hybrid cloud that is a combination of a public cloud and a private cloud. For example, the cloud 175 may be public, private, or hybrid. Public clouds 108 may include public servers that are maintained by third parties to the clients 165 or the owners of the clients 165. The servers may be located off-site in remote geographical locations as disclosed above or otherwise. Public clouds 175 may be connected to the servers over a public network 170. Private clouds 175 may include private servers that are physically maintained by clients 165 or owners of clients 165. Private clouds 175 may be connected to the servers over a private network 170. Hybrid clouds 175 may include both the private and public networks 170 and servers.

The cloud 175 may include back-end platforms, e.g., servers, storage, server farms, or data centers. For example, the cloud 175 can include or correspond to a server or system remote from one or more clients 165 to provide third-party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of the software, an application, or a software application to serve multiple users. Each tenant can include one or more clients. The multi-tenant environment can include user security features (e.g., identify management, single sign-on, etc.). In some embodiments, the computing environment 160 can provide on-demand self-service to unilaterally provision computing capabilities (e.g., server time, network storage) across a network for multiple clients 165. The computing environment 160 can provide elasticity to dynamically scale out or scale in responsive to different demands from one or more clients 165. In some embodiments, the computing environment 160 can include or provide monitoring services to monitor, control, and/or generate reports corresponding to the provided shared services and resources.

In some embodiments, the computing environment 160 can include and provide different types of cloud computing services. For example, the computing environment 160 can include Infrastructure as a Service (IaaS). The computing environment 160 can include Platform as a Service (PaaS). The computing environment 160 can include server-less computing. The computing environment 160 can include Software as a Service (SaaS). For example, the cloud 175 may also include a cloud-based delivery, e.g., Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers, or virtualization resources from large pools, allowing the users to quickly scale up by accessing more resources as needed. Examples of IaaS include AMAZON WEB SERVICES provided by Amazon.com, Inc., of Seattle, Washington; RACKSPACE CLOUD provided by Rackspace US, Inc., of San Antonio, Texas; Google Compute Engine provided by Google Inc. of Mountain View, California; or RIGHTSCALE provided by RightScale, Inc., of Santa Barbara, California. PaaS providers may offer functionality provided by IaaS, including, e.g., storage, networking, servers, or virtualization, as well as additional resources such as, e.g., the operating system, middleware, or runtime resources. Examples of PaaS include WINDOWS AZURE provided by Microsoft Corporation of Redmond, Washington; Google App Engine provided by Google Inc.; and HEROKU provided by Heroku, Inc., of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc.; SALESFORCE provided by Salesforce.com Inc. of San Francisco, California; or OFFICE 365 provided by Microsoft Corporation. Examples of SaaS may also include data storage providers, e.g., DROPBOX provided by Dropbox, Inc., of San Francisco, California; Microsoft SKYDRIVE provided by Microsoft Corporation; Google Drive provided by Google Inc.; or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g., GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as e.g., Advanced Encryption Standard (AES). Data resources may be sent over Transport Layer Security (TLS) or Secure Sockets Layer (SSL).

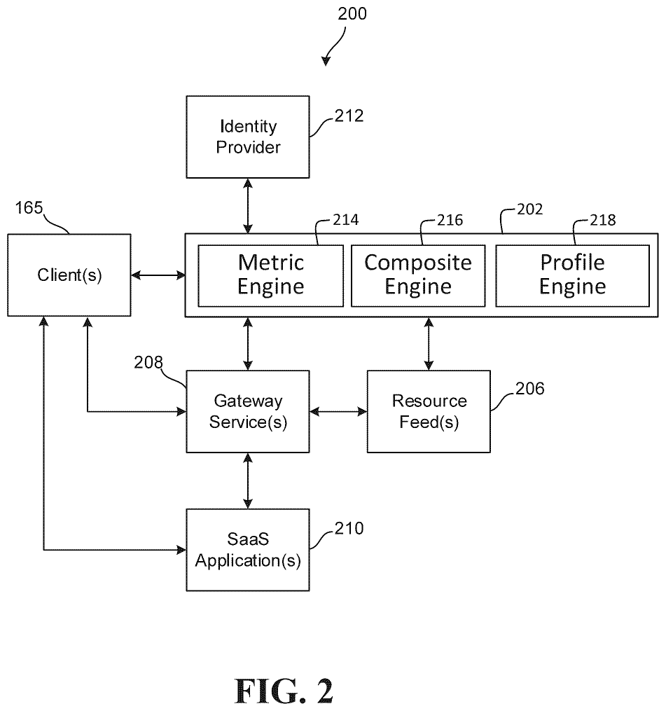

FIG. 2 is a block diagram of an example system 200 in which a profile generation engine 202 may generate an interactive electronic platform on a user interface and transmit the user interface to the clients 165. Users of the clients 165 may access the interactive electronic platform and submit requests for a list of early adopters (e.g., medical personnel that are likely to prescribe a medical product (e.g., a medical product of a specific type) to patients) and/or metrics of medical personnel. The profile generation engine 202 may receive the request and receive data from resource feeds 206 that provide clinical data and/or online interaction data regarding different medical entities. The profile generation engine 202 may feed the clinical data and/or online interaction data through a metric engine 214 (e.g., one or more machine learning models or other types of models) to generate one or more metrics for individual medical entities. One example of such a metric is a score indicating a likelihood that a medical personnel will prescribe a medical product (e.g., a medical product of a requested type). Other examples of metrics the metric engine 214 can calculate for medical personnel include, but are not limited to, cost sensitivity, chemotherapy preference, safety preference, biologics preference, immuno-oncology preference, oral preference, and subcutaneous versus intravenous preference. After obtaining or receiving the metrics from the metric engine, the profile generation engine 202 may feed the metrics through a composite engine 216. The composite engine 216 may be a model (e.g., a machine learning model) trained or configured to receive such metrics for individual medical personnel and generate composite scores for the medical personnel.

As described herein, medical personnel may include doctors, physicians, dentists, nurses, social workers, and/or any other type of medical worker.

The profile generation engine 202 may feed the metrics and/or the composite score into the profile engine 218. The profile engine 218 may receive the metrics and/or composite scores for the individual medical personnel and insert the metrics and/or composite scores into profiles (e.g., data structures such as tables including rows or columns for each metric and/or the composite score) for each respective medical personnel. The profile generation engine 202 may generate a record that includes data for the individual profiles. The profile generation engine 202 may rank the profiles according to one or more of the metrics. The profile generation engine 202 may include the rankings in the respective profiles. The profile generation engine 202 may do so based on a request the profile generation engine 202 receives from one of the clients 165. The profile generation engine 202 may generate a user interface including the record and/or data of the record and transmit the user interface to the requesting client 165.

In one example, the profile generation engine 202 may employ an identity provider 212 to authenticate the identity of a user of a client 165 and, following authentication, grant the user access to the interactive electronic platform. Via the accessed client 165, the user may input a request for an early adopter prediction. In some cases, the user may input a type of medical product in the request. The profile generation engine 202 may receive the input and execute a model in the metric engine 214. In some implementations, the client 165 may communicate with the profile generation engine 202 via gateway services 208. In some implementations, the client 165 may access the profile generation engine 202 directly through SaaS application(s) 210. The SaaS application(s) 210 may allow the client 165 to access the electronic platform discussed herein and view data that was collected from the resource feeds 206.

The client(s) 165 may be any type of computing device capable of accessing the resource feeds 206 and/or the SaaS applications 210, and may, for example, include a variety of desktop or laptop computers, smartphones, tablets, etc. Each of the profile generation engine 202, the resource feeds 206, the gateway services 208, the SaaS applications 210, and the identity provider 212 may be located within an on-premises data center of an organization for which the system 200 is deployed, within one or more cloud computing environments, or elsewhere.

### Section B: Profile Generation System

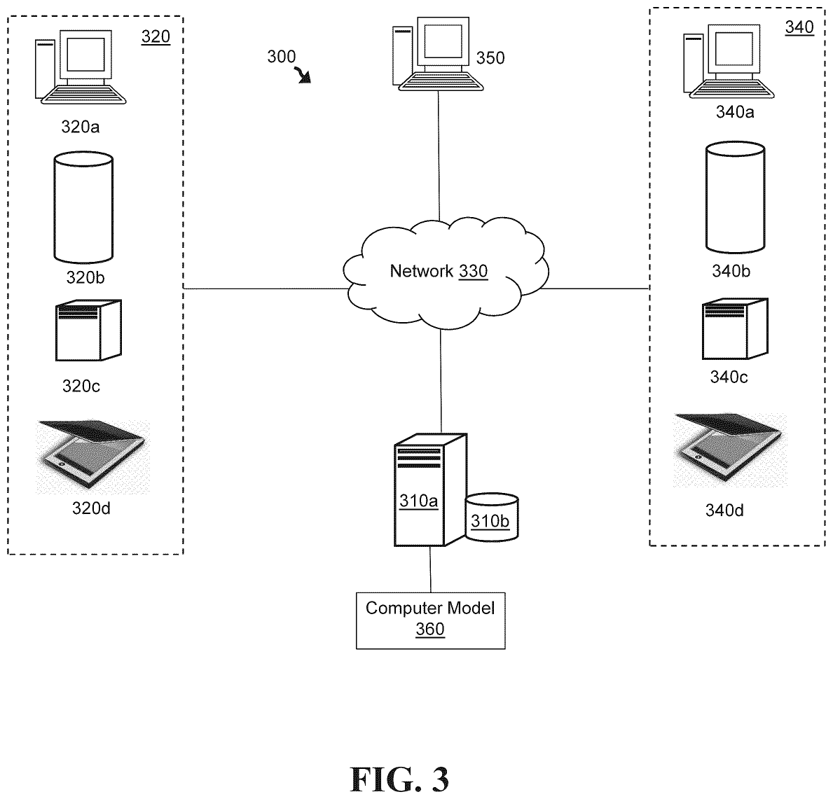

As will be described throughout, a server of a profile generation system 300 (such as an analytics server 310a) can retrieve and analyze data using various methods described herein to generate profiles for medical personnel. The server may do so using multiple models that are each configured and/or trained to calculate different metrics for medical personnel. The models may be trained to do so based on online interaction data and/or clinical data that the server scrapes from different websites and/or retrieves from databases. The server may input the metrics into a composite score model to trained to generate composite scores for medical personnel. In doing so, the server may optimize recommendations for medical personnel based on different attributes the server receives in requests. FIG. 3 is a non-limiting example of components of the profile generation system 300 in which the analytics server 310a operates. The analytics server 310a may be any computer, server, or processor.

The analytics server 310a may utilize components described in FIG. 3 to retrieve data and to generate/display results. The analytics server 310a may be communicatively coupled to a system database 310b, electronic data sources 320a-d (collectively electronic data sources 320), end-user devices 340a-d (collectively end-user devices 340), and/or an administrator computing device 350. The system 300 is not confined to the components described herein and may include additional or alternative components, not shown for brevity, which is to be considered within the scope of the embodiments described herein.

The above-mentioned components may be connected through a network 330. The examples of the network 330 may include, but are not limited to, private or public LAN, WLAN, MAN, WAN, and the Internet. The network 330 may include both wired and wireless communications according to one or more standards and/or via one or more transport mediums.

The analytics server 310a may utilize one or more application programming interfaces (APIs) to communicate with one or more of the electronic devices described herein. For instance, the analytics server may utilize application programming interfaces (APIs) to automatically receive data from the electronic data sources 320. The analytics server 310a can receive data as it is generated, monitored, and/or processed by the respective electronic data source 320. For instance, the analytics server 110a may utilize an API to receive clinical data and/or online interaction data from the database 320b without any human intervention. This automatic communication allows for faster retrieval and processing of data.

As described herein, clinical data is data that is descriptive or otherwise associated with a medical field, a medical topic, a medical professional (e.g., a doctor, nurse, or social worker), and/or a healthcare provider (HCP). Examples of clinical data include, but are not limited to competitive engagement data, data from congress, clinical trial data, publication data, real-world data, channel affinity data, speaker bureau customer master affiliation data and engagement data, etc. Clinical data can also include industry engagement, and leadership engagement data. The clinical data may be associated with medical entities if the medical entities were involved in generating the clinical data (e.g., the medical personnel authored or co-authored a publication, the medical personnel performed a clinical trial and uploaded the data for the clinical trial, etc.). In some implementations, to establish the association between a medical personnel and clinical data, the analytics server may receive the clinical data and scan (e.g., using optical character recognition (OCR) techniques and/or a fuzzy matching algorithm (e.g., an edit distance formula)) the clinical data to determine if there is a string that matches a medical personnel's name. If there is a match, the analytics server 110a may label the data or a personnel profile associated with the medical personnel to indicate the clinical data is associated with the medical personnel.

Similarly, as described herein, online interaction data may be or include any actions that a medical personnel takes on a web-based property (e.g., a website, a web page, a social media page such as a personal profile, a user account page, etc.), such as posting a blog post, commenting on an article or a picture, liking an article or an image, viewing a video including the amount of time the user viewed the video, direct messages, relationships (e.g., connections or friendships), etc. Online interaction data may include data about a user's online profile, such as friends, connections, other types of relationships between the profile and other online profiles. In some implementations, online interaction data may be clinical data.

The analytics server 310a may generate and/or host an electronic platform having a series of graphical user interfaces (GUIs) configured to use various computer models to project and display data associated with medical personnel. The electronic platform can be displayed on the electronic data sources 320, the administrator computing device 350, and/or end-user devices 340. An example of the electronic platform generated and/or hosted by the analytics server 310a may be a web-based application or a website configured to be displayed on different electronic devices, such as mobile devices, tablets, personal computers, and the like. Even though certain embodiments discuss the analytics server 310a displaying the results, it is expressly understood that the analytics server 310a may either directly generate and display the electronic platform described herein or may present the data to be presented on a GUI displayed on the end-user devices 340.

The analytics server 310a may host a website (also referred to herein as the electronic platform) accessible to users operating any of the electronic devices described herein (e.g., end-users). In some implementations, the content presented via the various web pages may be controlled based on each particular user's role or viewing permissions. The analytics server 310a may be any computing device comprising a processor and non-transitory machine-readable storage capable of executing the various tasks and processes described herein. Non-limiting examples of such computing devices may include servers, computers, workstation computers, personal computers, and the like. While this example of the system 300 includes a single analytics server 310a, in some configurations, the analytics server 310a may include any number of computing devices operating in a distributed computing environment.

The analytics server 310a may execute one or more software applications configured to display the electronic platform (e.g., host a website), which may generate and serve various web pages to each electronic data source 320 and/or end-user devices 340. Different end-users (e.g., pharmaceutical sales, medical and marketing professionals, etc.) may use the website to view and/or interact with the predicted results.

The analytics server 310a may be configured to require user authentication based on a set of user authorization credentials (e.g., username, password, biometrics, cryptographic certificate, and the like). In such implementations, the analytics server 310a may access the system database 310b configured to store user credentials, which the analytics server 310a may be configured to reference to determine whether a set of entered credentials (purportedly authenticating the user) match an appropriate set of credentials that identify and authenticate the user.

The analytics server 310a may also store data associated with each user operating one or more electronic data sources 320 and/or end-user devices 340. The analytics server 310a may use the data to determine whether a user device is authorized to view results generated by the computer model(s) discussed herein, such as a computer model 360.

The computer model 360 may be any collection of one or more algorithms and/or machine-readable code that can ingest clinical data and/or online interaction data associated with a medical personnel. The computer model 360 may be configured to generate metrics and/or composite scores to include in personnel profiles. The computer model 360 may include one or more mathematical algorithms, optimization or a statistical ranking algorithms (e.g., Technique for Order of Preference by Similarity to Ideal Solution (TOPSIS) such as Multi-Criteria Decision Making (MCDM) TOPSIS) artificial intelligence or machine learning models (e.g., neural network, a long short term memory neural network, boosting, bagging machine learning, random forest, regression, transformer models, etc.) that can be trained in accordance with data received from the electronic data sources 320 and/or end-user devices 340. In some implementations, the analytics server 310 may use the data collected from the electronic data sources 320 to generate a training dataset and further train the computer model 360 using various machine learning training techniques (e.g., supervised, unsupervised, or semi-supervised training).

The analytics server 310a may receive or retrieve clinical data and/or online interaction data from end-user devices 340 and/or electronic data sources 320. The electronic data sources 320 may represent different databases or third-party vendors who possess medical data, marketing data, clinical trial data, online interaction data, and the like. For instance, the electronic data sources 320 may represent computers, databases, and servers of a medical provider that can provide additional information regarding a clinical trial. In some implementations, the analytics server 310a may scrape social media websites (which may be hosted by electronic data sources 320) to retrieve data from the websites such as connection data (e.g., data indicating the medical entities are connected with each other through the websites), comments, blog posts, likes, and/or any other type of online interaction data.

The analytics server 310a may use the data collected from the electronic data sources 320 and received from the end-user device 340 to execute the computer model 360. The analytics server 310a may display the results via the electronic platform (e.g., GUIs) on the administrator computing device 350 or the end-user devices 340.

The end-user devices 340 may be any computing device comprising a processor and a non-transitory machine-readable storage medium capable of performing the various tasks and processes described herein. Non-limiting examples of an end-user device may include workstation computers, laptop computers, tablet computers, and server computers. In operation, various end-users may use end-user devices 340 to access the electronic platform operationally managed by the analytics server 310a to request and view early adopters and/or medical personnel with other traits, as predicted by the analytics server 310a using the model 360.

The administrator computing device 350 may represent a computing device operated by a system administrator. The administrator computing device 350 may be configured to display retrieved data, in the form of results generated by the analytics server 110a, where the system administrator can monitor various models utilized by the analytics server 110a, review feedback, and modify various thresholds/rules described herein.

The analytics server 310a may access, generate, and execute various computer models. Although the example system 300 depicts the computer model 360 stored on the analytics server 310a, the model 360 may be stored on another device or server (e.g., stored locally or in cloud storage).

In operation, the analytics server 310a may collect various types of clinical data and/or online interaction data about, generated by, or otherwise associated with, different medical personnel. The analytics server 310a may train the one or more models of the computer model 360 to develop algorithms to calculate metrics for the individual medical personnel. In one example, the analytics server 310a may train a model (e.g., a machine learning model) using machine learning techniques to predict likelihoods that medical personnel will be early adopters of different types of medical products. The analytics server 310a may train the model to receive as input clinical data of a medical personnel and a type of medical product and provide as output a score identifying a likelihood of the medical personnel to prescribe a medical product of the type of medical product within a defined time period relative to a launch of the medical product. The analytics server 310a may train the model to do so using clinical data and/or online interaction data that the analytics server receives and/or retrieves. The analytics server 310a may similarly train or configure any number of models of the computer model 360 to predict values or scores for any other metrics (e.g., types of metrics) for medical personnel. When one or more of the models of the computer model 360 is sufficiently trained (e.g., trained to be accurate above a threshold) and/or configured, the analytics server 310 may implement the computer model 360 and allow end-users to use the computer model 360 to request metrics (e.g., values for metrics) for different medical personnel based on different inputs or attributes in requests.

For instance, an end-user may use any of the end-user devices 340 to access the electronic platform and request to view medical personnel that are the most likely to be an early adopter of an arthritis medication. The analytics server 310a may execute a model of the computer model 360 using an indication of an arthritis medication type and clinical data and/or online interaction data of respective medical personnel as input. The model may output a score for each of the medical personnel. The analytics server 310a may compare the scores with each other and generate a ranked list of the medical personnel ranked in order (e.g., ascending or descending order) based on their respective scores. The analytics server 310a may generate a record comprising strings identifying the ranked order, in some cases only including a defined number of the highest ranked medical personnel from the list. The analytics server 310a may transmit the record to the requesting end-user device 340 for display, in some cases with the generated scores for each of medical personnel included in the record.

The electronic platform may include various GUIs discussed herein where each GUI may include various input elements allowing the end-user to request to view different metrics and/or composite scores for medical personnel and/or rankings of medical personnel according to such metrics and/or composite scores.

### Section C: Profile Generation Method

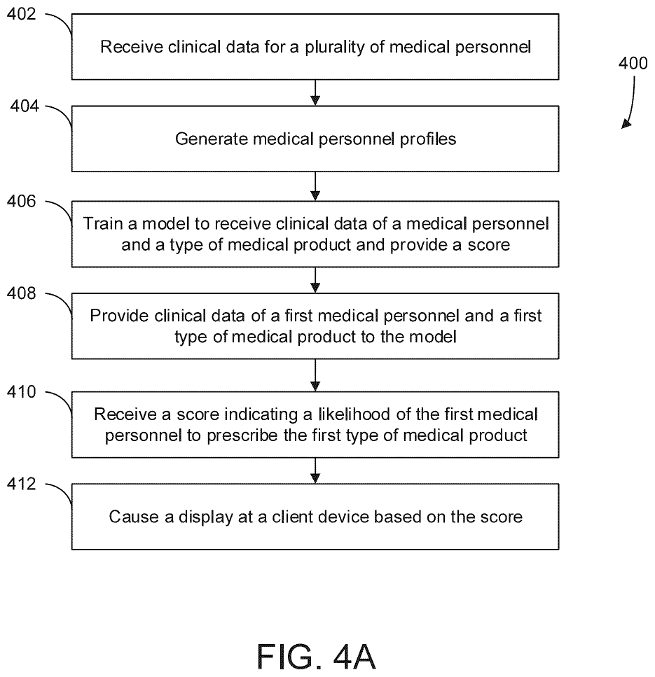

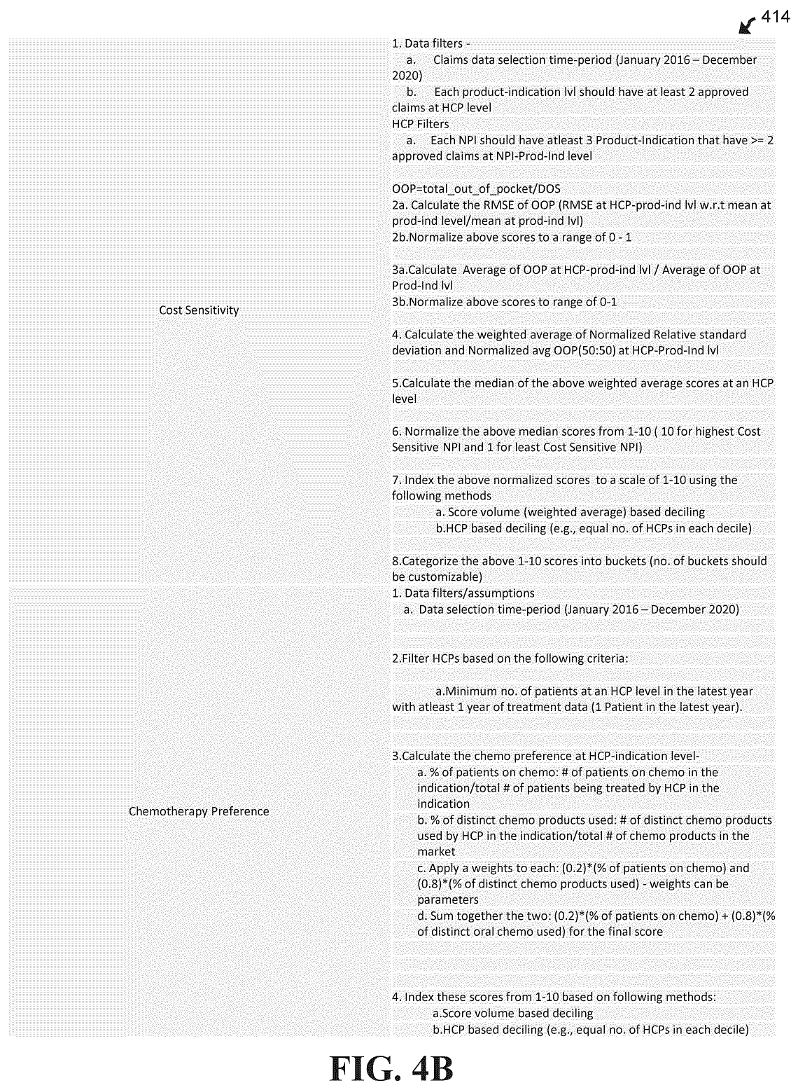

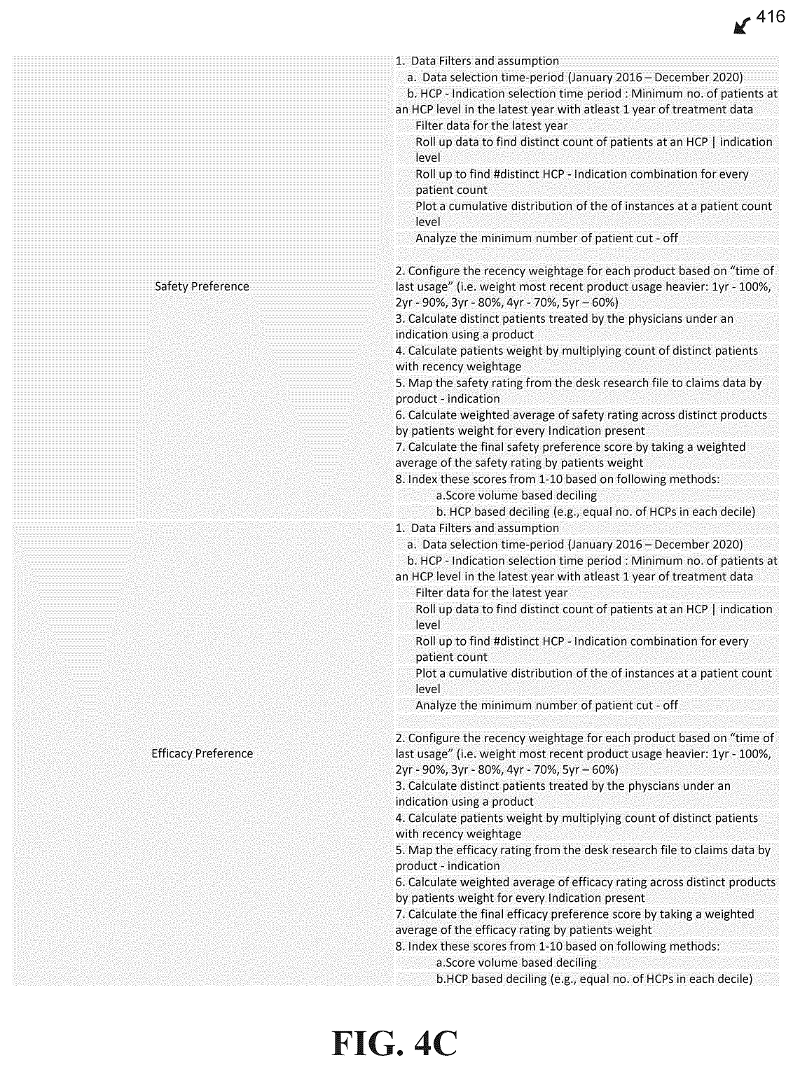

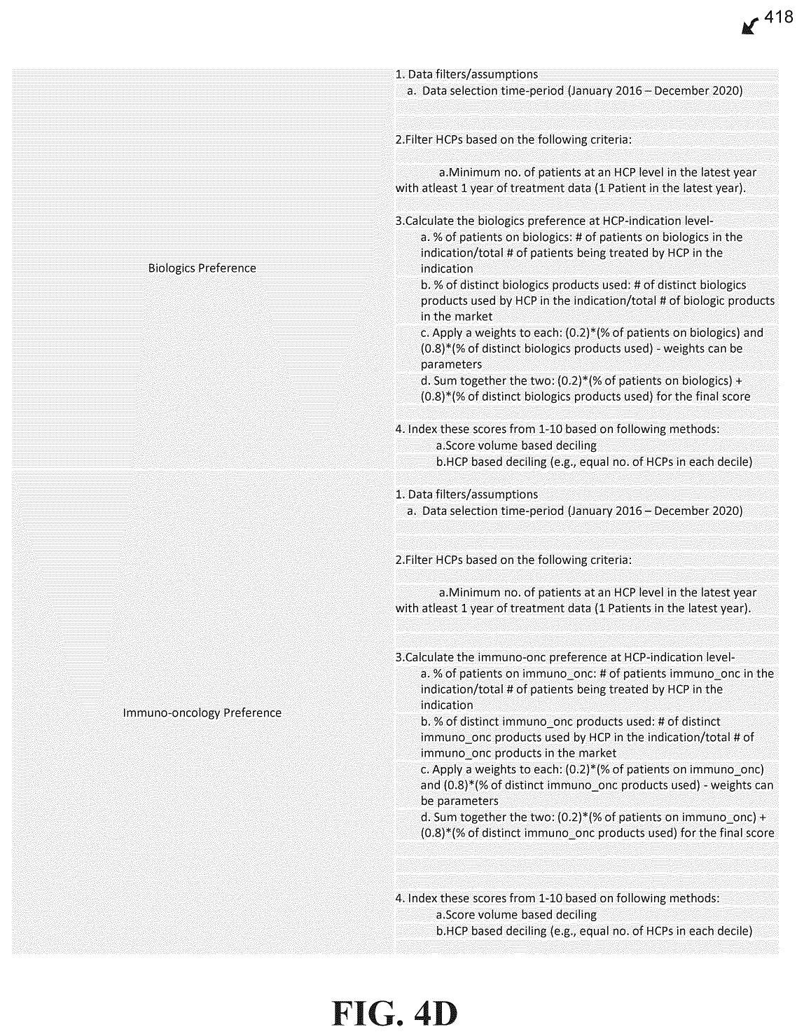

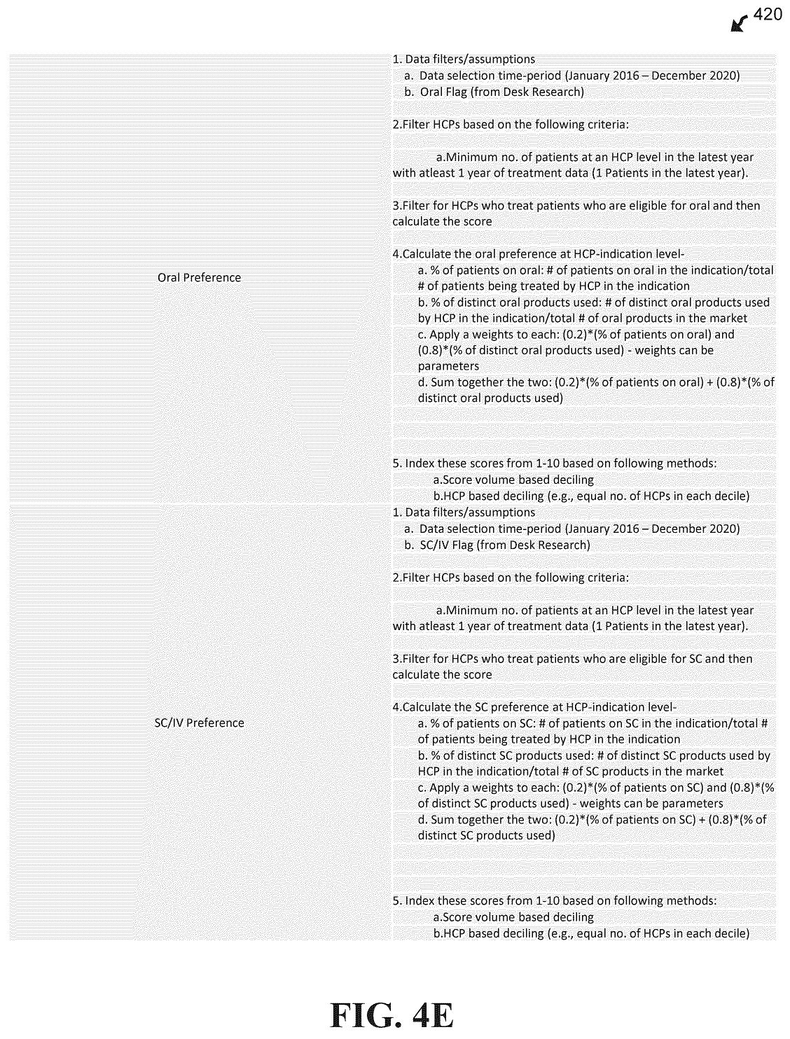

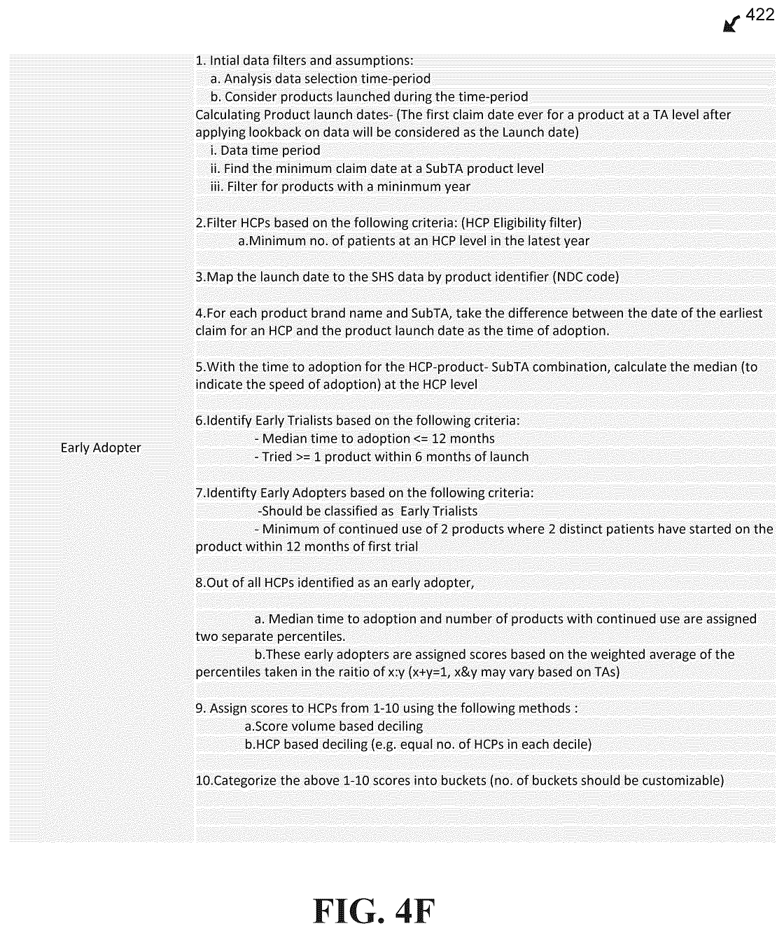

Referring now to FIG. 4, a flowchart of an example method 400 for implementing a machine learning architecture for early adopter prediction is shown, in accordance with one or more implementations. The method 400 may be performed by a data processing system (e.g., the profile generation engine 202, the analytics server 310a, a client device 165, or any other computing device). The method 400 may include any number of steps and the steps may be performed in any order. Performance of the method 400 may enable the data processing system to use a series of models to automatically filter medical personnel based on scores and requests from client devices. Performance of the method 400 may enable the data processing system to generate medical personnel profiles for medical personnel that can provide a broad view of the preferences and/or performance of different medical personnel. Such profiles may be useful for potential patients determining which medical personnel is best fit for treating their medical needs. In performing the method 400, the data processing system may select and generate a list of medical personnel that are the most fit for the needs of patients. The data processing system may do so based on clinical data and online-interaction data associated with the respective medical personnel.

At operation 402, the data processing system may receive clinical data and/or online interaction data for a plurality of medical personnel. The data processing system may receive multiple different types of clinical data and receive the clinical data from different sources. For example, the data processing system may receive online interaction data, competitive engagement data, data from congress, clinical trial data, publication data, patient claims, real-world data, channel affinity data, speaker bureau customer master affiliation data and engagement data, etc., from various servers or computing devices. In some cases, the different servers or sets of servers may provide different types of data (e.g., one server may provide clinical data, such as medical trial data, while another server may provide online interaction data). In one example, the clinical data may be or include publications authored or co-authored by the individual medical entities. In some implementations, the clinical data and/or online interaction may include text and/or images describing different medical fields such as new procedures, medical inventions, diseases, diagnosis techniques, etc.

The data processing system may receive the clinical data through different methods, depending on the data source. In one example, the data processing system may receive clinical data from a data source after the data source transmitted the clinical data to the data processing system. Such may be the case, for example, when the data processing system has a pre-existing relationship (e.g., an established connection) with the data source and the data source is configured to transmit new clinical data to the data processing system upon receipt of the data, upon a defined time interval passing, or upon receipt of a request for the clinical data from the data processing system. In another example, the data processing system may use web-scraping techniques to retrieve data from various web pages. To do so, the data processing system may retrieve data from the servers or computers hosting the website after identifying the clinical data and/or online interaction and the medical entities that are associated with (e.g., named in) the clinical data or online interaction data. Such may be the case, for example, when the data processing system retrieves data from social media websites. In some implementations, the data processing system may collect online interaction data and/or clinical data using screen-scraping techniques on the websites.

At operation 404, the data processing system may generate medical personnel profiles. The data processing system may generate the medical personnel profiles in a network graph data structure (e.g., a data structure such as a database in memory configured to store profiles). The data processing system may generate the medical personnel profiles and the network graph data structure from the received clinical data and online interaction data. Medical personnel profiles may be data structures that include medical entities' names, demographic information about the medical entities, and/or any clinical data or online interaction data the data processing system has stored in the respective medical personnel profiles. In some implementations, the data processing system may store pointers to the locations of the clinical data and/or online interaction data in the medical personnel profiles, thus conserving memory resources by avoiding storing duplicative copies of clinical data and/or online interaction data locally when the data can be accessed and retrieved from another host computing device or database. Each profile may include a string identification of the medical personnel that is associated with the profile and/or a unique identifier the data processing system generates (e.g., generates using a pseudo-random number generator). The data processing system may use such identifications to link or insert new clinical data and/or online interaction data into the respective profiles and/or to group the medical personnel profiles together for fast retrieval.

To generate the medical personnel profiles, the data processing system may implement various matching techniques (e.g., exact matching or fuzzy matching) between strings in data files or data packets in the clinical data and/or online interaction data and strings in the individual profiles. For example, the data processing system may identify and/or extract a name of an author from a publication from a particular field the data processing system may be trained to query, or from text the data processing system identified using natural language processing techniques (NLP). The data processing system may identify either exact matches (e.g., matching strings in which each character matches) or fuzzy matches (e.g., matching strings that do not have the exact same characters, but are similar above a defined threshold percentage or number of characters) between the identified strings of names in the clinical data and the different medical personnel profiles. In some implementations, the data processing system may identify fuzzy matches based on a comparison between the strings and/or using an edit distance algorithm. Upon identifying a match between a file or data packet of clinical data and a medical personnel profile, the data processing system may store the file or data packet in the matching medical personnel profile.

In some cases, the data processing system may identify a name in the clinical data or online interaction data that does not match names in any medical personnel profiles stored in memory (e.g., in the network graph data structure). When this occurs, the data processing system may “enrich” the network data structure and generate a new data structure for a new profile containing the name. After generating the new profile, the data processing system may perform the same updating steps as listed above to update the profile with clinical data associated with the name.

The data processing system may store clinical data in the profiles regarding prescriptions the medical personnel make for medical products (e.g., vaccines, medicine, antibiotics, medical equipment, etc.). For example, the data processing system may identify files that include patient claims (e.g., claims for prescriptions for medical products to insurance) from the clinical data the data processing system receives. From the patient claims, the data processing system may identify names of medical products, prescriptions for the medical products, and/or times (e.g., timestamps) in which the patient claims were filed. The data processing system may additionally identify the medical personnel that prescribe the medical products from the patient claims. In some cases, the data processing system may identify the types of medical products from the patient claims. The data processing system identify the data using natural language processing techniques on the text in the files of the patient claims. The data processing system may identify the medical personnel profiles that correspond to the medical personnel that prescribed the medical products from memory and store the identified data from the patient claims in the respective medical personnel profiles. Accordingly, the data processing system may store data indicating times in which medical personnel prescribed different medical products to patients in memory.

The data processing system may store medical product data in memory. Medical product data may be any type of data that corresponds to specific medical products, such as, for example, medical product type, launch date and/or time, side effects, values, treatment plans, treatment timeline, diseases or problems the medical products are designed to cure or treat, etc. The data processing system may store the medical product data in profiles (e.g., medical product profiles) for the medical products, which may be stored in memory. The data processing system may retrieve the medical product data from clinical data such as publications and/or announcements regarding the medical products. For example, the data processing system may use natural language processing techniques on publications, announcements, and/or any other type of clinical data, to identify different medical products and aspects regarding the medical products. Using such techniques, the data processing system may identify or extract data such as, for example, a timing or time of a launch (e.g., a release to the public or medical personnel for sale) of a medical product and/or a type of the medical product. The data processing system may store the identified data in the profiles for the medical products. Accordingly, the data processing system may populate profiles for medical products with extracted data regarding the medical products.

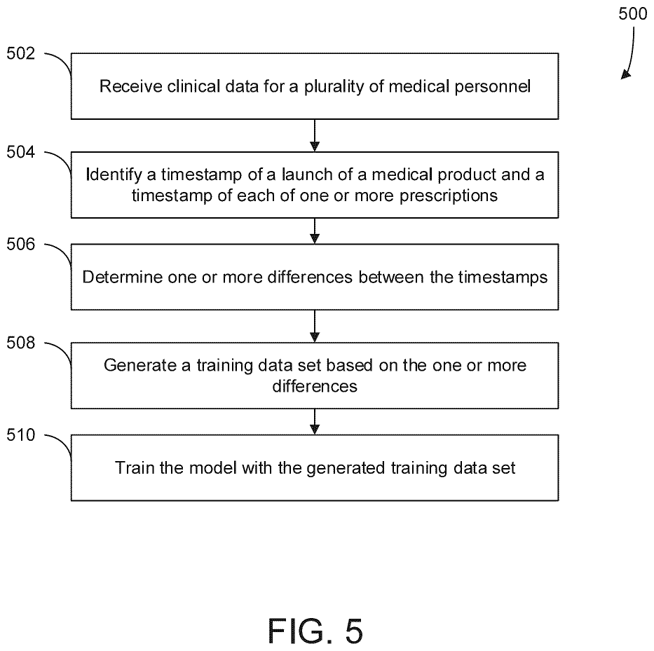

At operation 406, the data processing system may train a model. The model may be a machine learning model (e.g., a neural network, a support vector machine, random forest, a regression model, a clustering model, etc.). The data processing system may train the model using machine learning techniques (e.g., supervised, semi-supervised, or unsupervised training techniques). The data processing system may train the model to receive clinical data of a medical personnel and a type of medical product and provide a score. The score may indicate a likelihood of a medical personnel to prescribe a medical product of a type of medical product within a defined time period relative to a launch of the medical product. The data processing system may train the model using clinical data and/or data from medical personnel profiles and/or medical product profiles, as described with reference to FIG. 5.

At operation 408, the data processing system may provide clinical data of a first medical personnel and a first type of medical product to the model. The data processing system may provide the clinical data of the first medical personnel and the first type of medical product to the model in response to receiving a request from a client device. The request may include an identification of the first type of medical product. Responsive to receiving the request, the data processing system may retrieve the clinical data that corresponds to the individual medical personnel from the medical personnel profiles of the medical personnel. The data processing system may generate a feature vector for each of the medical personnel, including the first medical personnel, from the clinical data that corresponds to the medical personnel. The data processing system may insert an identification of the first type of medical product into each of the feature vectors. The data processing system may then separately insert each of the feature vectors into the model. The data processing system may execute the model using each of the feature vectors as input.

At operation 410, the data processing system may receive a score. The score may indicate a likelihood of the first medical personnel to prescribe the first type of medical product. The data processing system may receive the score from the model responsive to executing the model with the feature vector including clinical data of the first medical personnel. The data processing system may receive such scores for each medical personnel for which the data processing system created a feature vector and executed the model using the feature vector as input.

At operation 412, the data processing system may cause a display. The data processing system may cause the display at a client device (e.g., the client device that transmitted the request containing the identification of the first type of medical product). The data processing system may cause the display based on the score.

The data processing system may cause the display by causing the score to be displayed at the client device. To do so, the data processing system may transmit an identification of the first medical personnel and/or the score for the first medical personnel to the client device. The client device may receive the identification of the first medical personnel and/or the score and locally display the received identification of the first medical personnel and/or the score at a display or user interface of the client device. In some embodiments, the data processing system may generate a user interface. The data processing system may include the identification of the first medical personnel and/or the score in the user interface and transmit the user interface to the client device. The client device may receive the user interface and display the received user interface.

In some embodiments, the data processing system may display an indication of whether the first medical personnel is an early adopter. To do so, the data processing system may compare the received score for the first medical personnel to a threshold (e.g., a predetermined threshold). Responsive to determining the score exceeds the threshold, the data processing system may determine first medical personnel is an early adopter (e.g., has an early adopter trait). Otherwise, the data processing system may determine the first medical personnel is not an early adopter. The data processing system may insert an indication in the medical personnel profile for the first medical personnel indicating whether the first medical personnel is an early adopter based on the comparison. In some cases, the data processing system may insert the score into the medical personnel profile instead of or in addition to the indication. The data processing system may store the indication with an identification of the first type of medical product, thus labeling the first medical personnel based on whether the first medical personnel is an early adopter. The data processing system may transmit an identification of the first medical personnel and/or the indication of whether the first medical personnel is an early adopter to the client device, in some cases in a user interface. The client device may receive and display the identification of the first medical personnel and/or the indication. In this way, the data processing system may provide a user of the client device information regarding whether the first medical personnel is an early adopter of the first type of medical product.

In one example, the data processing system may store the score for the first medical personnel by inserting the score into a cell of a table. The cell may be an intersection between a row and a column of the table. The row may a row dedicated to storing such scores and the column may be dedicated to storing values of metrics. The data processing system may similarly store an indication of whether the medical personnel is an early adopter in another cell of the table (e.g., in the same row but a different column of the table). The data processing system may store scores and/or indications of other metrics for the medical personnel in the table. The data processing system may store the scores and/or indications in different rows but the same columns as the respective columns for the early adopter metric. The indications may indicate whether or not the medical personnel has the trait that corresponds to the metric (e.g., whether the score for the metric exceeds a threshold).

The data processing system may generate a ranked list of medical personnel. For example, as described above, the data processing system may separately provide clinical of a plurality of medical personnel to the model as input. The data processing system may include the identification of the first type of medical product in the input for each medical personnel. The data processing system may execute the model based on each input and output a score (e.g., early adopter score) for each of the medical personnel accordingly. The data processing system may compare the scores for the medical personnel between each other. Based on the comparison, the data processing system may rank (e.g., assign values of rankings to) the medical personnel in ascending or descending order according to the scores to generate a ranked list of the medical personnel (e.g., a list in ascending or descending order based on the rankings). The data processing system may transmit the ranked list to the client device. The client device may receive and display the ranked list.

In some implementations, the data processing system may compare the scores for the each of the medical personnel to the threshold. Based on the comparison, the data processing system may determine whether the medical personnel are early adopters of medical products of the first type of medical product. The data processing system may store indications in the medical personnel profiles of the medical personnel indicating whether the comparison indicates the medical personnel are early adopters for the first type of medical product or not. In some cases, the data processing system may insert the scores into the medical personnel profiles instead of or in addition to the indications. The data processing system may include the indications in the ranked list that the data processing system transmits to the client device (e.g., with associations with the medical personnel to which the scores correspond). The data processing system may include the indications in the ranked list in addition to or instead of the scores of the medical personnel. The client device may receive the indications and/or scores with the ranked list and display the received indications and/or scores.

In some implementations, the data processing system may select the first medical personnel from the ranked list. The data processing system may select the first medical personnel based on the ranking and/or score of the first medical personnel. For example, the data processing system may identify the first medical personnel as the highest ranked medical personnel of the ranked list. The data processing system may select the first medical personnel according to the identification. In some cases, the data processing system may select multiple medical personnel from the ranked list. For example, the data processing system may be configured or requested (e.g., in the request from the client device) to identify a defined number (e.g., five) of medical personnel that correspond to the highest rankings. The data processing system may select the defined number of highest ranked medical personnel. The data processing system may use any such ranking criteria to select medial personnel. The data processing system may transmit identifications of the selected medical personnel to the client device instead of the entire ranked list (thus lowering the bandwidth requirements of transmitting the list), or in addition to the ranked list, such as in a separate list or the ranked list includes indications of the selected medical personnel.

In some cases, the data processing system may select the first medical personnel in response to determining the score for the medical personnel satisfies a threshold. The data processing system may do so instead of or in addition to selecting the first medical personnel based on the ranking of the first medical personnel. For example, the data processing system may compare the score for the first medical personnel to a threshold. Responsive to determining the score exceeds the threshold and/or the first medical personnel satisfies a ranking criterion as described above, the data processing system may select the first medical personnel. The data processing system may similarly select a subset of the medical personnel based on the scores for the subset satisfying the threshold and/or satisfying a ranking criterion. In some cases, the data processing system may first filter out options for medical personnel from which to select by identifying medical personnel that satisfy the ranking criterion and then only comparing scores for the identified medical personnel to the threshold, or vice versa. Thus, the data processing system may minimize the processing resources that are required to select medical personnel.

The data processing system may determine multiple metrics for the medical personnel. Examples of such metrics include, but are not limited to, early adopter, cost sensitivity, chemotherapy preference, safety preference, biologics preference, immuno-oncology preference, oral preference, and subcutaneous versus intravenous preference. The data processing system may calculate or determine each of the metrics using different models (e.g., machine learning models, analytical models, optimization models, etc.) that have been trained or configured to generate values for the individual metrics.

In one example, the data processing system may determine different metrics for a medical personnel using a series of rules. For example, the data processing system may determine the metrics according to assumptions and/or operations 414-420 illustrated in FIGS. 4B-4E. The operations 412-420 illustrated in FIGS. 4B-4E may In some embodiments, the data processing system determines or calculates the early adopter metric for a medical personnel according to assumptions and/or operations 422 illustrated in FIG. 4F.

The data processing system may store different models that have been trained or configured to calculate or determine different metrics upon execution. The models may be trained or configured based on the inputs listed for the respective metrics. The data processing system may retrieve the inputs from the medical personnel profiles of the different medical personnel. The data processing system may have previously identified the values for the inputs from clinical data associated with the respective medical personnel. The data processing system may input the retrieved data for each of the medical personnel into each of the models. The data processing system may execute each model using the inputs to calculate or determine values of the metrics for each medical personnel. The data processing system may insert the values for the metrics into the medical personnel profiles (e.g., cells of tables of the medical personnel profiles) of the medical personnel for which the values were calculated or determined.

In one example, as illustrated in FIG. 4B, the data processing system may execute a model configured to calculate a cost sensitivity for a medical personnel. The model may be configured to do so based on the out-of-pocket expenses the medical personnel typically incurs in claims made by the medical personnel's patients. For instance, the data processing system may identify claims made by patients of the medical personnel for a defined time period (e.g., January 2016-January 2020). The data processing system may retrieve the out-of-pocket expense from each of the claims. The data processing system may aggregate the retrieved out-of-pocket expenses together to generate a total out-of-pocket expense value (OOP). The data processing system may divide the total out-of-pocket expense value by the number of claims for the medical personnel from which the total out-of-pocket expense value was generated to calculate an out-of-pocket expense value for the medical personnel. The data processing system may similarly calculate out-of-pocket expense values for different types of products by identifying the types of products from the claims and calculating average out-of-pocket expense values for the respective types of products. The data processing system may calculate the root-mean-square error (RMSE) of the out-of-pocket expense values for each product type for the medical personnel. The data processing system may normalize the RMSE and/or the average out-of-pocket expense values for each product type for the medical personnel to a range of 0-1. The data processing system may calculate an average (e.g., a weighted average) for each product type of the RMSE and the average out-of-pocket expense for claims of the product type. The data processing system may calculate a median of the averages for the medical personnel. The data processing system may normalize the median to a value between 1 and 10 (e.g., based on similarly calculated medians for other medical personnel). The data processing system may index the normalized scores to a scale of 1-10 using score volume (e.g., weighted average)-based deciling or medical personnel-based deciling (e.g., an equal number of medical personnel in each decile). The data processing system may categorize the scores (e.g., the median values normalized to values between 1 and 10). The data processing system may categorize the scores into buckets (e.g., one bucket includes values between 1 and 3, another bucket includes values between 4 and 7, and another bucket includes values between 8 and 10). The buckets can encompass any range within the scale.

In another example, as illustrated in FIG. 4B, the data processing system may execute a model configured to calculate chemotherapy preference for a medical personnel. The model may be configured to do so based on the number of patients the medical personnel treats using chemotherapy (e.g., chemotherapy products). In some cases, the data processing system may only determine such preferences for medical personnel that have treated at least one (or another defined number) patient using chemotherapy in the last year (or another time period). To do so, the data processing system may maintain and increment a counter for the number of patients the doctor treats using chemotherapy and maintain and increment a separate counter for the number of chemo products the medical personnel prescribes. The data processing system may increment the counters based on patient claims and other treatment data the data processing system has stored for the medical personnel. The data processing system may determine a weighted sum for the medical personnel based on the percentage of patients the medical personnel treats with chemotherapy (e.g., treats using chemotherapy compared to other treatments, in some cases only other treatments for cancer) and the percentage of chemotherapy products the medical personnel prescribes (e.g., treatments using chemotherapy products compared to other treatment products, in some cases only other treatment products for cancer). The data processing system may index the weighted sums into values between 1 and 10 based on similarly calculated scores for other medical personnel (e.g., using score volume-based deciling or medical person-based deciling (e.g., an equal number of medical personnel may be in each decile)).

In another example, as illustrated in FIG. 4C, the data processing system may execute a model configured to calculate a safety preference for a medical personnel. The model may be configured to do so based on the safety ratings of products the medical personnel prescribes to patients. In some cases, the data processing system may only determine such safety preference ratings for medical personnel that have treated at least a defined threshold number of patients (e.g., a defined threshold number of patients for a defined time period, such as for the past year). For example, the data processing system may identify the safety ratings of medical products in claims made by patients of a medical personnel. The data processing system may calculate an average of the safety ratings across medical products. In some cases, the data processing system may calculate a weighted average based on the times of the claims for the medical products in which claims associated with more recent times (e.g., contain more recent timestamps) are weighted higher. The data processing system may similarly calculate weighted averages for any number of medical personnel. The data processing system may index the weighted averages into values between 1 and 10 (e.g., using score volume-based deciling or medical person-based deciling (e.g., an equal number of medical personnel in each decile)).

In another example, as illustrated in FIG. 4C, the data processing system may execute a model configured to calculate an efficacy preference for a medical personnel. The model may be configured to calculate efficacy preferences (e.g., efficacy preferences, weighted averages, and/or index values for efficacy preferences) for medical personnel in a similar manner to how the model for the chemotherapy preference calculates chemotherapy preferences for medical personnel, as described above.

In other examples, as illustrated in FIGS. 4D-4E, the data processing system may execute models configured to calculate biologics preferences, immune-oncology preferences, and/or subcutaneous versus intravenous preferences for medical personnel. The models may be configured to calculate such preferences (e.g., scores or values (e.g., weighted averages), normalized index values, and/or buckets for the preferences) for medical personnel in a similar manner to how the model for the chemotherapy preference metric calculates chemotherapy preferences for medical personnel, as described above.

In another example, as illustrated in FIG. 4F, the data processing system may execute a model to calculate an early adopter metric (e.g., the same early adopter metric as described herein) for medical personnel. In doing so, the data processing system may identify the earliest times (e.g., based on claims from patients) in which the medical personnel prescribed individual medical products. The data processing system may also identify the times of launches of the same medical products. The data processing system may calculate differences between the earliest times and the launches (e.g., times of beginnings of first trials) of the medical products. The data processing system may determine median times of adoption for the medical personnel as the medians of the differences the data processing system calculated for the individual medical personnel. The data processing system may additionally or instead identify the smallest difference the data processing system calculated for each medical personnel. The data processing system may label (e.g., insert indicator values in) the medical personnel profiles for the medical personnel as early trialists responsive to determining the median time to adoption for a medical personnel is less than or equal to a defined time period length (e.g., less than or equal to 12 months) or the medical personnel prescribed at least a defined number (e.g., one) of medical products within a defined time period length (e.g., six months). The data processing system may label medical personnel to be early adopters responsive to determining the medical personnel are early trialists and/or responsive to determining the same medical personnel prescribed two distinct products to two distinct patients within a defined time period (e.g., 12 months) of launch of the respective medical products.

The data processing system may analyze the medical personnel profiles the data processing system determined to be early adopters. For example, the data processing system may determine two different percentiles for each early adopter compared to the other early adopters, one percentile for the median time of adoption for the early adopter and another percentile for the number of products the medical personnel assigns within a defined time period from launch and/or that has continued use. The data processing system may calculate a weighted average of the two percentiles for each medical personnel. The data processing system may assign scores to the medical personnel based on the weighted averages (e.g., using score volume-based deciling or medical personnel-based deciling (e.g., an equal number of medical personnel in each decile)). The data processing system may assign the medical personnel into different buckets based on the scores, as described herein.

In some embodiments, the data processing system may determine scores and/or values for cross-therapy areas for a medical personnel. For example, the data processing system may identify the clinical data that corresponds to specific areas, such as breast cancer, lung cancer, skin cancer, etc. The data processing system may execute the models described herein based on the identified clinical data to calculate scores, metrics, rankings, and/or buckets for each of the specific areas for the medical personnel. In another example, the data processing system may combine data from multiple sub-areas (e.g., each of the different areas for cancer) and execute the models to calculate scores, metrics, rankings, and/or buckets for the combination of the multiple sub-areas. The data processing system may cause display of such scores at a client device (e.g., upon receipt of a request from the client device) by transmitting the scores, metrics, rankings, and/or buckets or a user interface containing such data to the client device. The data processing system may calculate such cross-therapy scores because the data processing system may establish and maintain connections with different data sources that store different types of data. The data processing system may pool data collected through each of the connections to generate the scores for the cross-therapy areas.

The data processing system may cause display of metrics (e.g., the values for the metrics) and/or the score (e.g., the early adopter score) the data processing system determined for the first medical personnel and/or any other medical personnel for which the data processing system calculated or determined such metrics and/or scores. The data processing system may cause display of the metrics and/or the score at a client device. To do so, the data processing system may transmit the metrics and/or the score to the client device. The client device may receive and display the metrics and/or the score. In some implementations, the data processing system may include the metrics and/or the score in a user interface and transmit the user interface to the client device. The client device may receive and display the user interface. The data processing system may cause the display of the metrics and/or the score at the client device in response to receiving a request for the metrics and/or the score.

The data processing system may determine a composite score for the first medical personnel. The composite score may be a general score for a medical personnel. The data processing system may determine the composite score for the first medical personnel based on the metrics and/or the score the data processing system determined for the first medical personnel. For example, the data processing system may train a model (e.g., a machine learning model) to generate composite scores based on metrics and/or a score for a medical personnel. The data processing system may train the model using a supervised learning technique, for example, such as by feeding metrics and scores of different medical personnel with labels for the medical personnel indicating the correct composite scores into the model. The data processing system may use back-propagation techniques based on a difference between the output of the model and the labels. Upon or responsive to being sufficiently trained (e.g., trained to have an accuracy above a threshold), the data processing system may input metrics and/or a score for the first medical personnel determined as described above into the model. The data processing system may execute the model to output a composite score for the first medical personnel. Accordingly, the data processing system may use machine learning techniques to determine a composite score for medical personnel.

In another example, the data processing system may determine the composite score for the first medical personnel according to one or more algorithms. For instance, the data processing system may assign weights to the different metrics or different types of metrics and calculate a weighted average of the metrics and/or score for the first medical personnel to be the composite score. The data processing system may use any such function to calculate or generate the composite score for the first medical personnel. Upon calculating or generating the composite score, the data processing system may cause display of the composite score at the client device. The data processing system may similarly calculate or generate composite scores for any number of medical personnel. The data processing system may cause display of the composite score by transmitting the composite score to the client device or by including the composite score in a user interface and transmitting the user interface to the client device. The data processing system may cause display of the composite score in response to receiving a request for a composite score that includes an identifier of the first medical personnel or that only includes a request for composite scores for medical personnel in general.

In some cases, the data processing system transmits the composite score for the first medical personnel in response to determining the composite score exceeds a threshold. The data processing system may compare the composite score to a threshold. The threshold may be a predetermined threshold or a threshold the data processing system receives in a request (e.g., a request for a composite score). Responsive to determining the composite score exceeds the threshold, the data processing system may transmit the composite score to the client device.

For example, the data processing system may receive a request for identifications of medical personnel that have a composite score that exceeds a first threshold. The first threshold may be identified or included in the request or may be defined in memory. The request may include an identification of a second product type. In response to receiving the request, the data processing system may determine a score (e.g., an early adopter score) for multiple medical personnel based on the identification of the second product type and as described herein. The data processing system may additionally calculate or retrieve other metrics (e.g., each other metrics for which the data processing system calculates values or metrics identified in the request) for each of the multiple medical personnel. The data processing system may generate and/or calculate composite scores for each of the multiple medical personnel. The data processing system may compare the composite scores to the first threshold. The data processing system may identify medical personnel that correspond to composite scores that exceed the first threshold. The data processing system may transmit identifications of the medical personnel with composites scores that exceed the first threshold to the requesting client device, in some cases with the composite scores that correspond to the medical personnel.

Referring now to FIG. 5, a flowchart of an example method 500 for training a machine learning architecture for early adopter prediction is shown, in accordance with one or more implementations. The method 500 may be performed by a data processing system (e.g., the profile generation engine 202, the analytics server 310a, a client device 165, or any other computing device). The method 500 may include any number of steps and the steps may be performed in any order. Performance of the method 500 may enable the data processing system to train and execute a machine learning model to determine scores (e.g., early adopter scores) for individual medical personnel. The method 500 may be performed as or during the operation 406 of the method 400, shown and described with reference to FIG. 4.

At operation 502, the data processing system may receive clinical data and/or online interaction data for a plurality of medical personnel. The data processing system may do so in the same manner as is described in the operation 402 of FIG. 4.

At operation 504, the data processing system may identify a timestamp of a launch of a medical product and a timestamp of each of one or more prescriptions. The data processing system may identify the timestamps from the clinical data (e.g., files for patient claims) and/or the online interaction data the data processing system receives at operation 502. For example, the data processing system may identify the timestamps using natural language processing techniques. In some cases, the data processing system may identify the timestamps from the profiles the data processing system has stored in memory. For example, the data processing system may identify a timestamp for the launch of the medical product from a stored medical product profile for the medical product and timestamps of prescriptions for the medical product from stored medical personnel profiles for the medical personnel. In some cases, the data processing system may identify a medical product type of the medical product from the clinical data and/or medical product profile.

At operation 506, the data processing system may determine one or more differences. The data processing system may determine differences between the timestamp of the launch of the medical product and the timestamps of the one or more prescriptions. To determine the differences, the data processing system may subtract the timestamp of the launch of the medical product from the timestamps of the prescriptions for the medical product or vice versa. The data processing system may determine the differences for each of the one or more prescriptions for the medical product.

At operation 508, the data processing system may generate a training data set. The data processing system may generate the training data set based on the one or more differences. For example, the data processing system may determine whether the medical personnel are early adopters of the medical product based on the differences that correspond to the medical personnel. The data processing system may compare the differences to a threshold and determine if the differences exceed the threshold. Responsive to determining a difference exceeds the threshold, the data processing system may determine the medical personnel that prescribed the medical product associated with the difference is an early adopter. Otherwise, the data processing system may determine the medical personnel is not an early adopter.

In some implementations, the data processing system may determine indications of whether a medical personnel is an early adopter based on prescriptions of the medical personnel for multiple medical products. For example, the data processing system may determine differences between timestamps of prescriptions of multiple medical products, and timestamps of launches of the medical products. The data processing system may identify differences that correspond to a medical personnel (e.g., differences between timestamps of launches of medical products and timestamps of prescriptions of the medical products by the medical personnel (e.g., the same medical personnel)). The data processing system may execute a function on the identified differences for the medical personnel to determine a value (e.g., a first value) such as to determine an average or median of the identified differences. The data processing system may compare the determined value to a threshold. The data processing system may determine whether the medical personnel is an early adopter or not based on whether the exceeds the threshold (e.g., the data processing system may determine the medical personnel is an early adopter responsive to determining the value is lower than the threshold). Responsive to the determination, the data processing system may generate and/or store an indication (e.g., a flag or binary value) in the medical personnel profile of the medical personnel based on the determination.

In some implementations, the data processing system may determine indications of whether medical personnel are early adopters depending on the types of medical products. For example, a medical personnel may be an early adopter of one type of medical product but not another type of medical product. The data processing system may generate and store such indications in the medical personnel profiles of the medical personnel. The data processing system may determine indications for different types of medical products for a medical personnel by segregating differences the data processing system determines for each medical personnel based on the types of medical products to which the differences correspond. The data processing system may identify the types of the medical products for which the differences are determined and label the differences according to the identified types. The data processing system may determine values (e.g., using a function such as an average or a median) from differences of a type of medical product for a medical personnel. The data processing system may similarly determine values for multiple types of medical products and/or for multiple medical personnel. The data processing system may compare the values to a threshold. The data processing system may compare the values to the same threshold or different thresholds for the different types of medical products. The data processing system may determine indications based on the comparisons. The data processing system may store the indications in the respective medical personnel profiles for which the differences were determined.

In some implementations, the data processing system may determine differences between timestamps of launches of medical products and timestamps of prescriptions for the medical products based on the earliest timestamps. For example, the data processing system may identify timestamps of different prescriptions that a medical personnel makes for a specific medical product. The data processing system may compare the timestamps together. The data processing system may identify the timestamp that corresponds to the earliest time and/or day based on the comparison. The data processing system may only determine a difference between the identified earliest timestamp and the timestamp of the corresponding launch of the medical product. In doing so, the data processing system may avoid using processing resources to determine differences for every single prescription for every single medical personnel, which can require a substantial amount of resources given the number of medical personnel for which the data processing system may determine differences. The data processing system may only use such calculated differences to identify early adopters. In some implementations, the data processing system may calculate differences for each prescription and only use the lowest calculated difference to identify early adopters.

In some implementations, the data processing system may determine multiple indications of early adopters for individual medical personnel, in some cases for individual types of medical products. The data processing system may do so using a plurality of thresholds. For example, the data processing system may compare a difference or a determined value, as described herein, to multiple thresholds that each correspond to a different value (e.g., three months, six months, 12 months, etc.). The data processing system may generate an indication for a medical personnel based on each comparison, in some cases with an identification of the threshold to which the data processing system compared the value. The data processing system may store each of the values in the medical personnel profiles of the medical personnel for which the values were generated.

The data processing system may generate feature vectors for the medical personnel. For example, the data processing system may retrieve clinical data that corresponds to the different medical personnel. The data processing system may retrieve the clinical data from the medical personnel profiles of the medical personnel and/or from a database. The data processing system may generate a feature vector for each of the medical personnel that includes clinical data that corresponds to the medical personnel. In some implementations, the data processing system may insert an identifier of the type of the medical product into each of the feature vectors. The data processing system may label the feature vectors with an indication that indicates whether the data processing system determined the medical personnel was an early adopter of a medical product of the type of the medical product based on the comparison of the difference associated with the medical personnel and the threshold (e.g., a comparison of the difference that was determined for the type of the medical product). The data processing system may a generate feature vector for each medical personnel that prescribed the medical product. The data processing system may similarly generate feature vectors for any number of medical products and/or medical personnel.

In implementations in which the data processing system determines multiple indications for a medical personnel and/or type of medical product, the data processing system may generate separate feature vectors for each indication. For example, the data processing system may generate multiple feature vectors for a medical personnel for a type of medical product and label each feature vector with a different indication determined based on a comparison between the same difference and a different threshold. Each feature may be used to train a different machine learning model (e.g., a machine learning model associated with the respective threshold).

At operation 510, the data processing system may train the model using the generated feature vectors. For example, the data processing system may insert the feature vectors into the model and execute the model. The model may output a score for each vector. The model may compare the score to the label and determine a difference between the output and the label. The data processing system may adjust the weights and/or parameters of the model by backpropagating the difference through the model. In this way, the data processing system may train the model to output scores indicating a likelihood that a medical personnel will be an early adopter of a medical product (e.g., a medical product of a certain type).

In implementations in which the data processing system generates feature vectors based on labels generated from different thresholds, the data processing system may train multiple machine learning models to output scores indicating a likelihood that a medical personnel will be an early adopter of a medical product (e.g., a medical product of a certain type). The data processing system may identify feature vectors that were labeled based on comparisons to a specific threshold and train a machine learning model based on the identified feature vectors. The data processing system may train any number of machine learning models based on such feature vectors identified based on different thresholds. Accordingly, the data processing system may train machine learning models that correspond to different definitions of what an early adopter is. The data processing system may provide scores and/or indications of whether medical personnel are early adopters based on the definitions in response to receiving a request including a value that corresponds to a particular threshold.

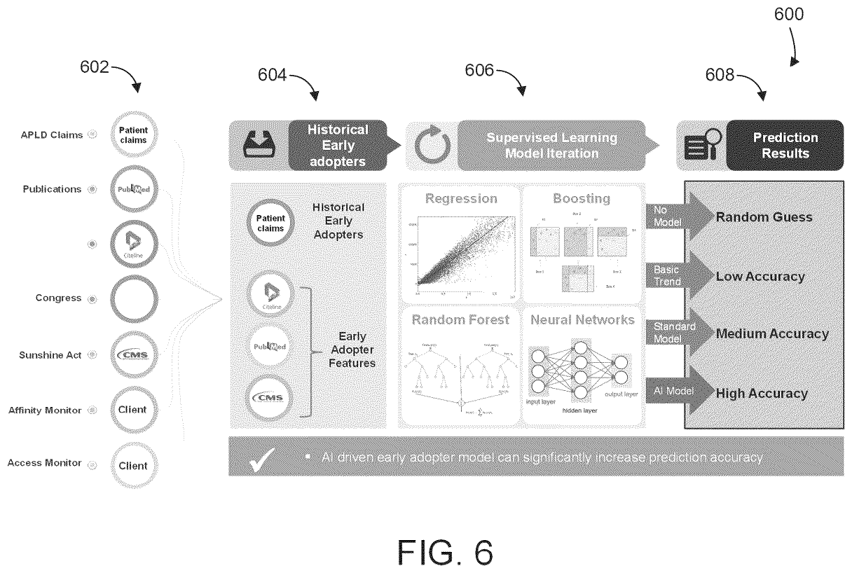

Referring now to FIG. 6, another example sequence 600 of implementing a machine learning architecture for early adopter prediction is shown, in accordance with one or more implementations. The sequence 600 may be performed by a data processing system (e.g., the profile generation engine 202, the analytics server 310a, a client device 165, or any other computing device). The sequence 600 may include any number of steps and the steps may be performed in any order. In some implementations, performance of the sequence 600 may enable the data processing system to generate scores for medical personnel indicating likelihoods that the medical personnel will be an early adopter for a type of medical product.

At operation 602, the data processing system can retrieve or receive clinical data from a variety of data sources. The data processing system may retrieve or receive the clinical data using one or more application programming interfaces. The application programming interfaces may enable the data processing system to connect and/or communicate with the computers of the data sources over a network. At operation 604, the data processing system can generate a training data set including clinical data and labels for feature vectors generated from the clinical data. Each feature vector may include clinical data of a different medical personnel. The labels for the feature vectors may indicate whether the respective medical personnel are early adopters. The data processing system may determine such labels based on timestamps the data processing system identifies from the clinical data. At operation 606, the data processing system may train one or more models (e.g., machine learning models, such as regression models, boosting models, random forest models, neural networks, etc.) to generate scores. The data processing system may train the models using the training data set generated at operation 604. The scores may indicate likelihoods that medical personnel will be early adopters for types of medical product. At operation 608, the data processing system may use the trained models to output scores (e.g., in response to receipt of a request) for a particular type of medical product.

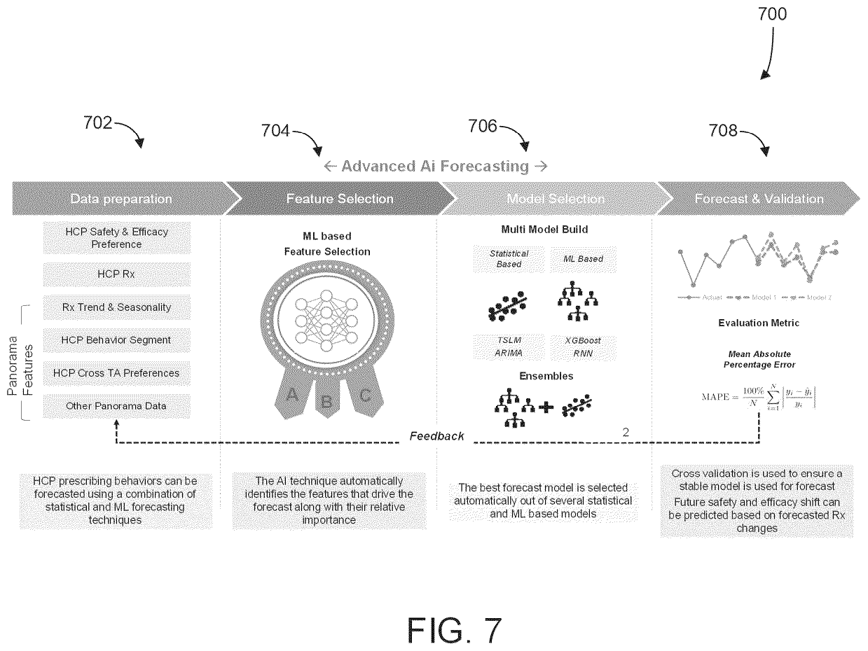

Referring now to FIG. 7, another example sequence 700 of implementing a machine learning architecture for early adopter prediction is shown, in accordance with one or more implementations. The sequence 700 may be performed by a data processing system (e.g., the profile generation engine 202, the analytics server 310a, a client device 165, or any other computing device). The sequence 700 may include any number of steps and the steps may be performed in any order. In some implementations, performance of the sequence 700 may enable the data processing system to generate scores for medical personnel indicating likelihoods that the medical personnel will be early adopters for a type of medical product.

At operation 702, the data processing system may prepare data. The data processing system may prepare data by calculating or generating scores or values for different metrics. The data processing system may calculate or generate such scores or values for individual medical personnel and store the scores or values in medical personnel profiles of the medical personnel. At operation 704, the data processing system may perform feature selection. The data processing system may perform feature selection by selecting the features (e.g., metrics) that are most relevant for forecasting scores for different metrics.

At operation 706, the data processing system may select a model. The data processing system may select a model from a group comprising statistical-based models, such as a time series linear model (TSLM) and an autoregressive integrated moving average (ARIMA), and machine learning-based models, such as an extreme gradient boosting (XGBoost) model and a recurrent neural network (RNN). In some cases, the data processing system may select multiple models. The data processing system may select the model or multiple models based on the accuracy of the model or models. The data processing system may individually train and/or determine accuracies for each of the models of the group, determine the accuracies of the models based on test data, and select the model the data processing system determines has the highest accuracy. The data processing system may determine accuracies of different subsets (e.g., ensembles) of models (e.g., models connected in a daisy chain configuration or models that each output a different value and execute a function, such as an averaging or a median calculating function, on the values). The data processing system may select the model based on the individual model or subset of models that the data processing system determines have the highest accuracy and/or an accuracy above a threshold.

At operation 708, the data processing system may perform forecasting and validation. The data processing system may identify the output of the selected model or subset of models and compare the output to actual data. The data processing system may calculate a mean absolute percentage error according to the comparison. The data processing system may train the models based on the calculated mean absolute percentage error. In this way, the data processing system may train one or more models to forecast scores for different metrics for medical personnel and predict changes in scores based on changes in prescriptions or medicine that becomes available.

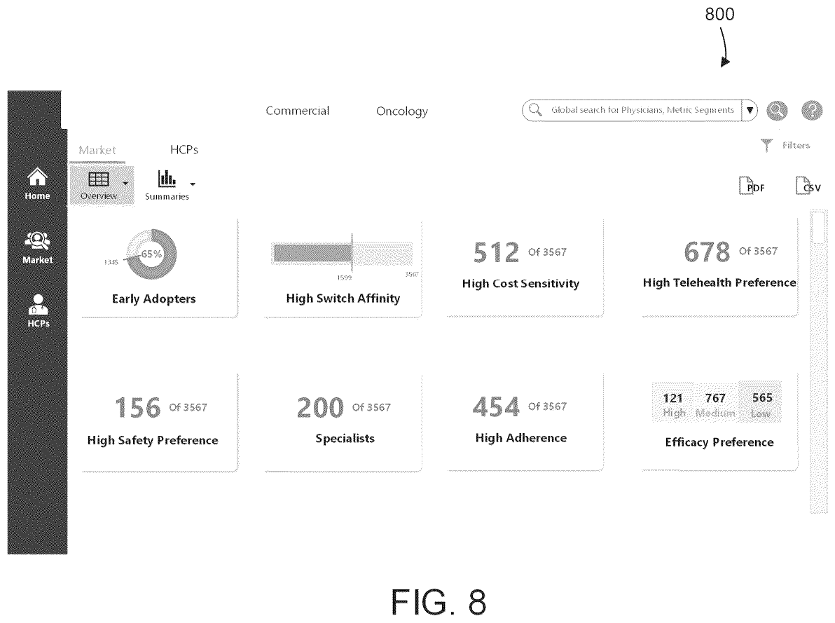

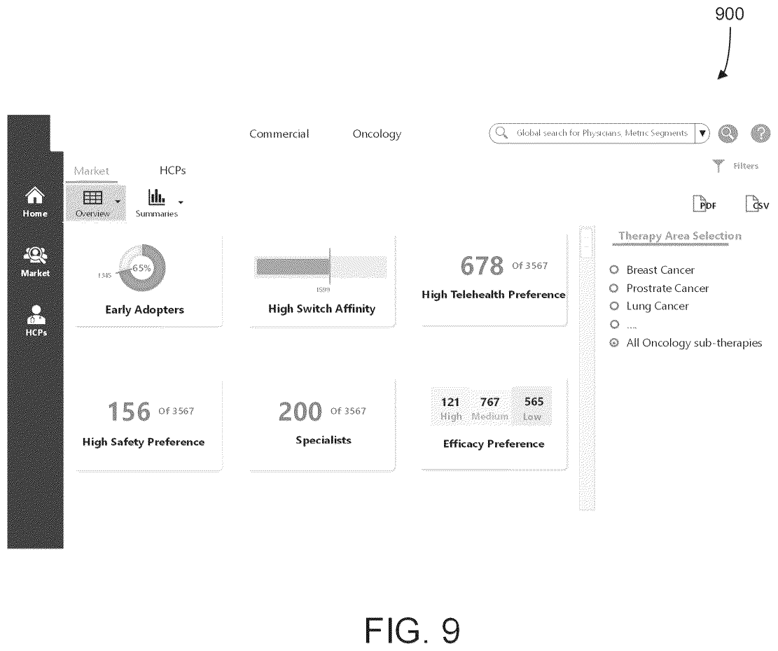

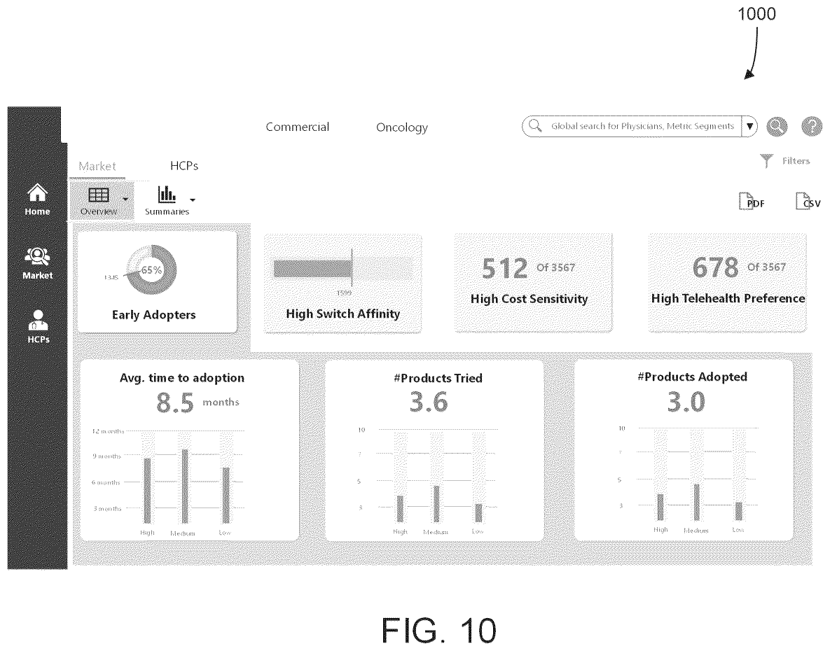

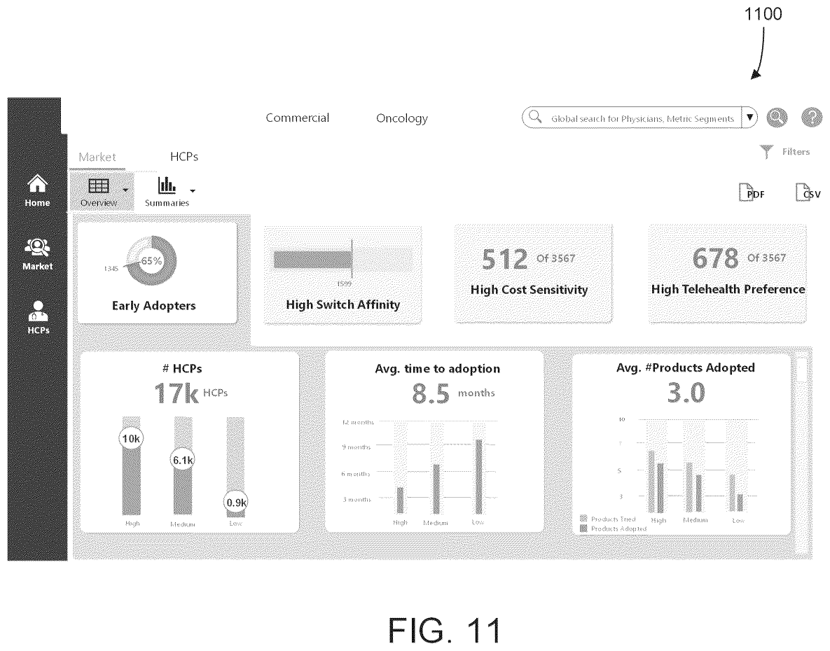

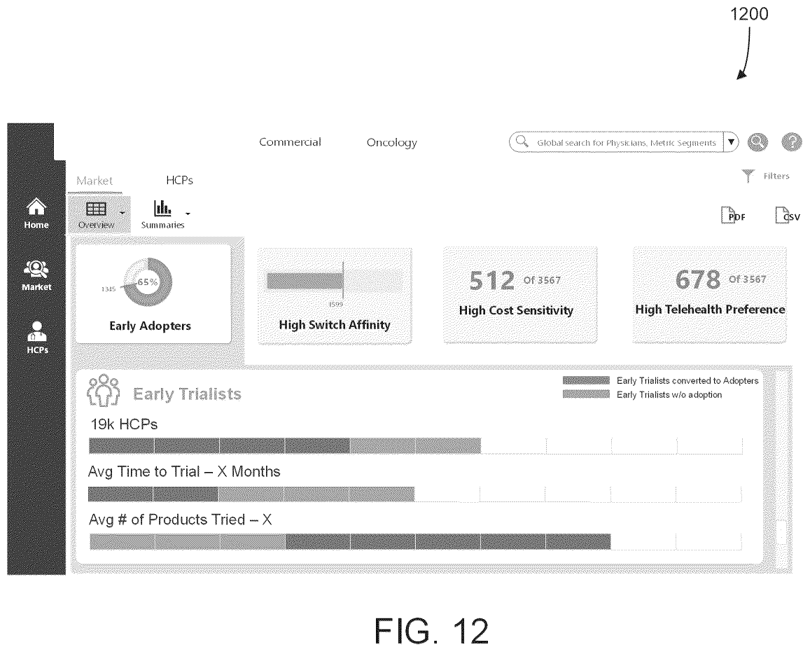

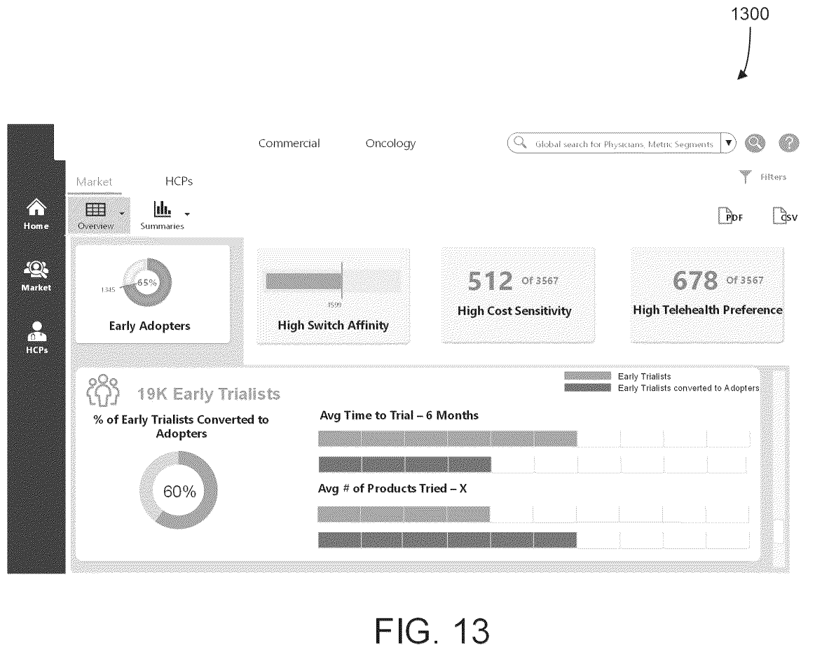

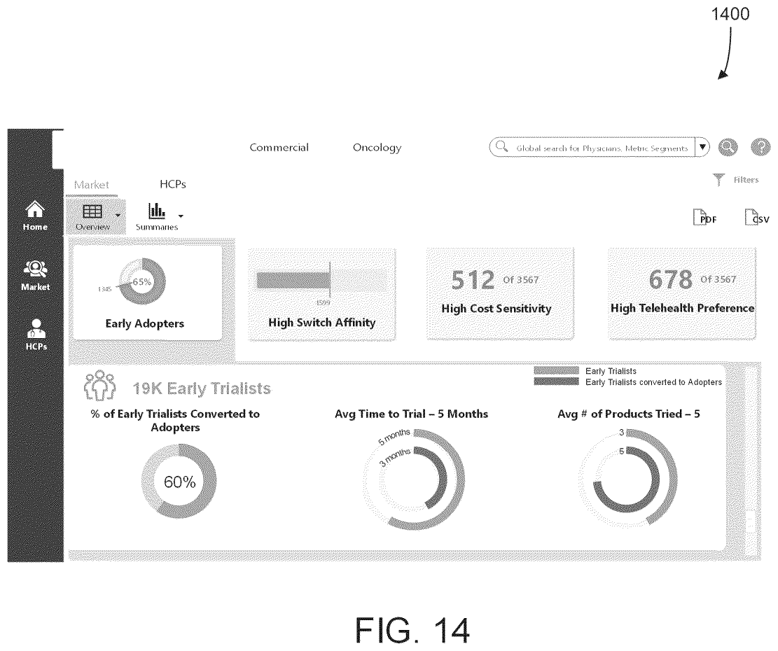

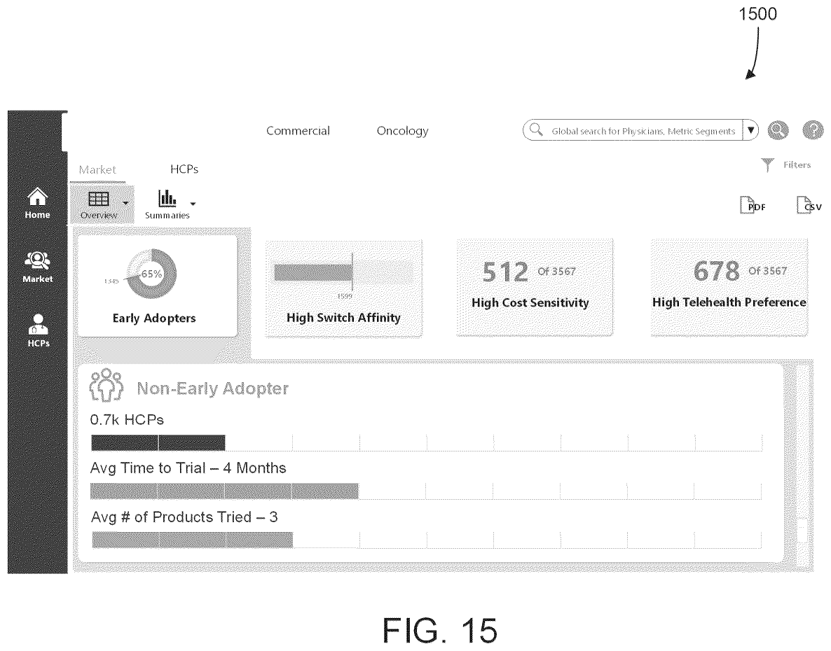

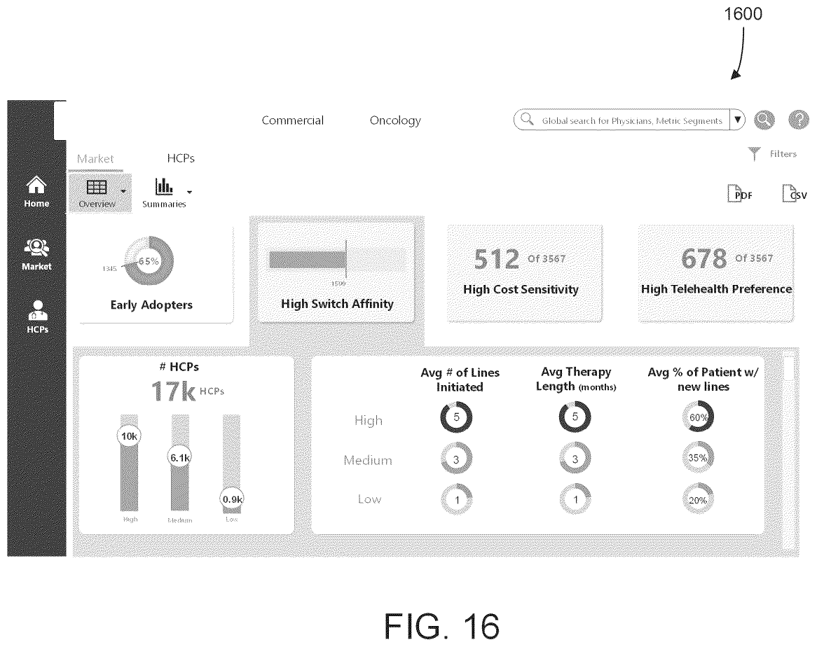

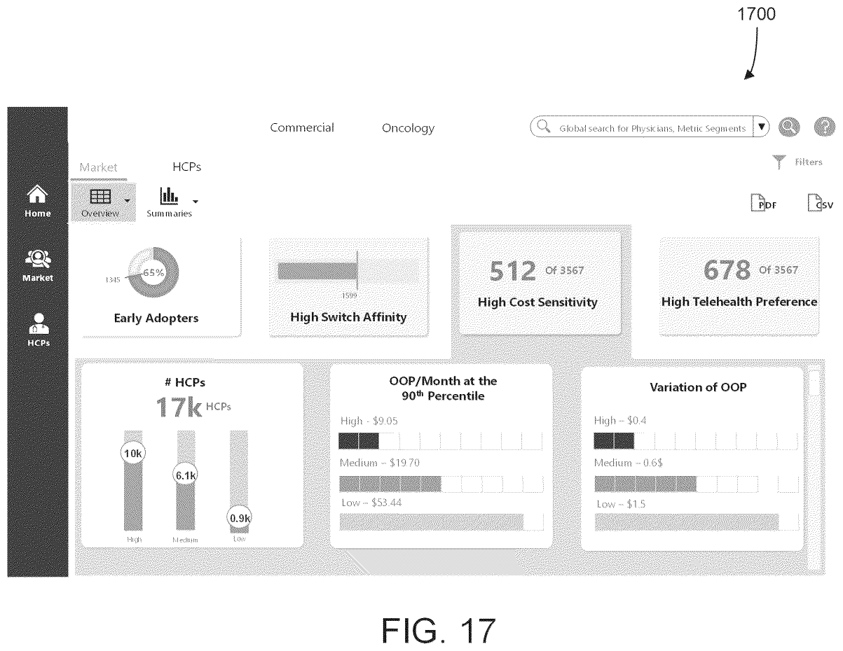

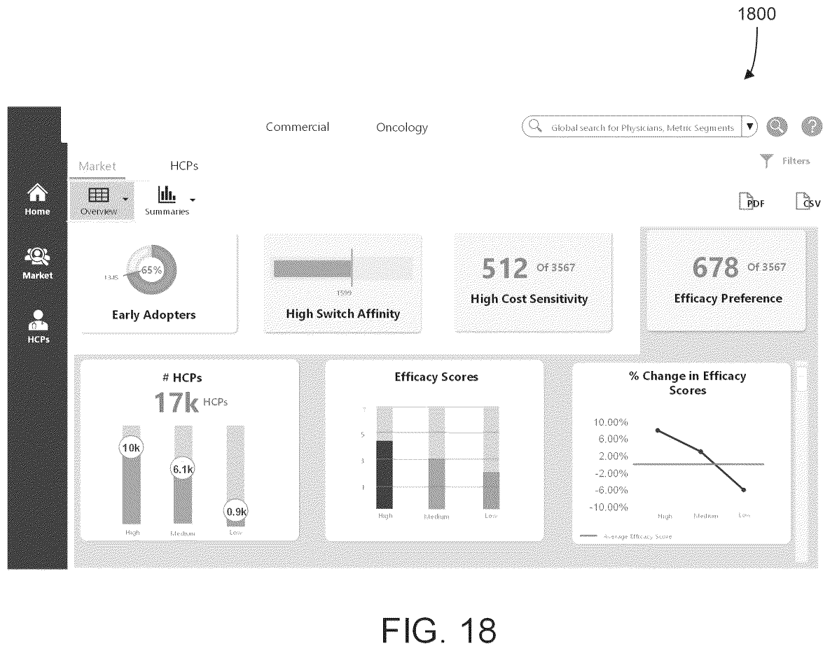

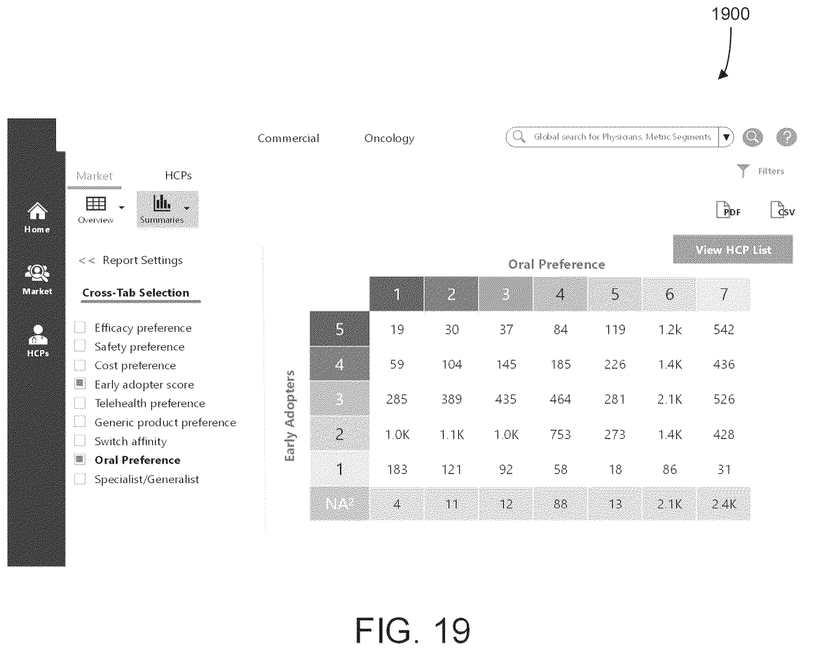

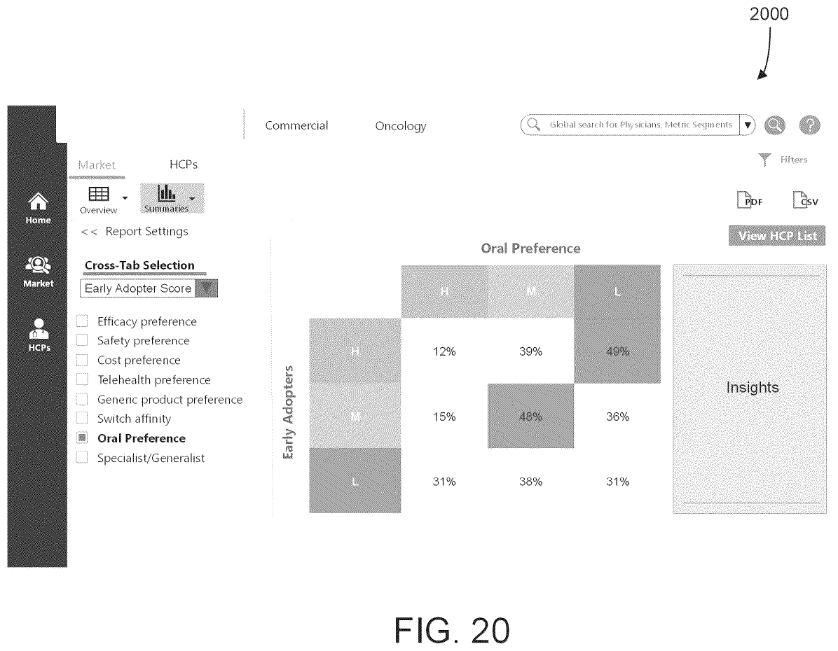

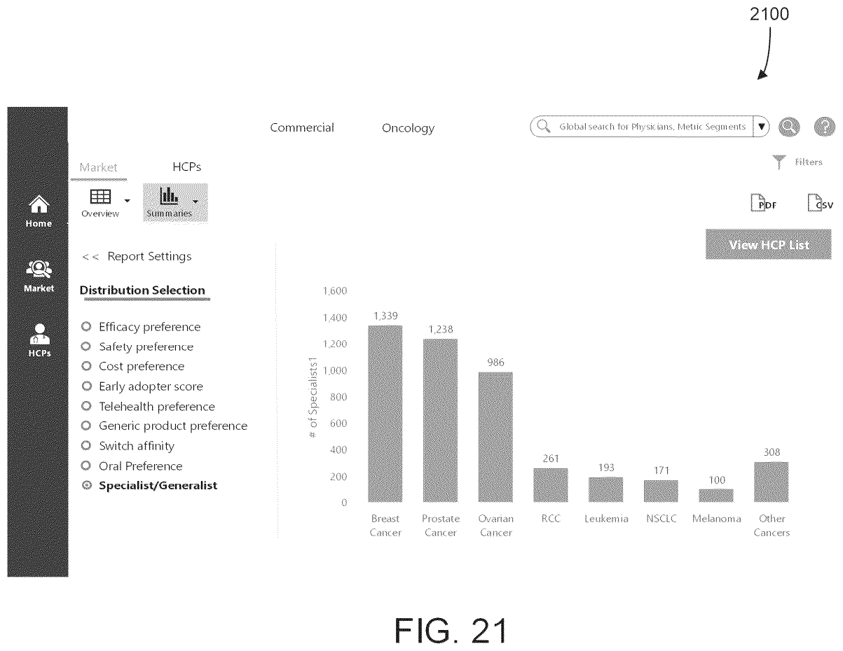

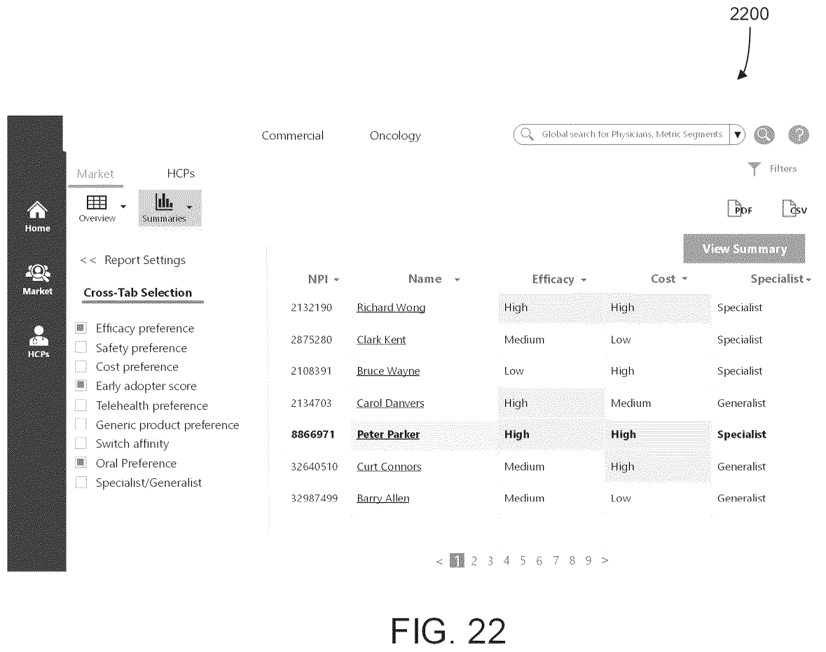

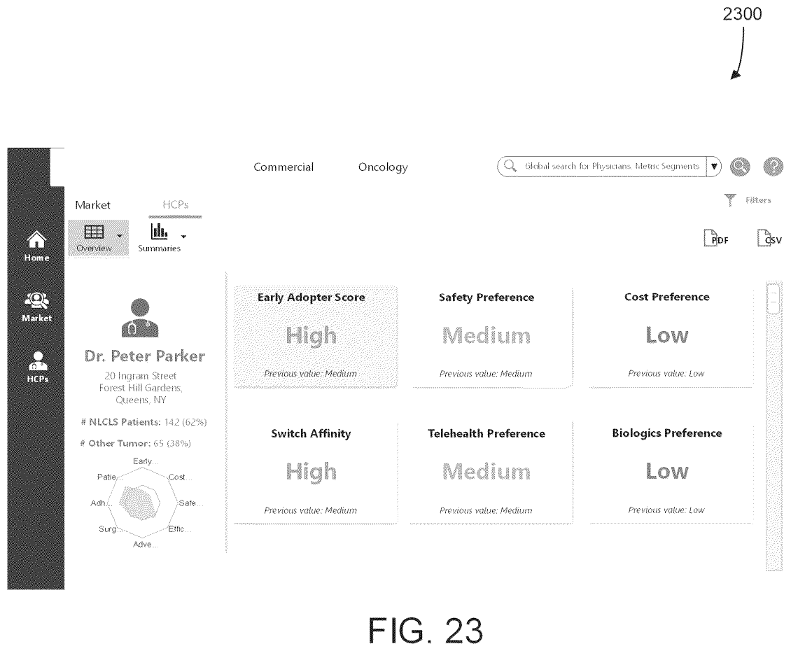

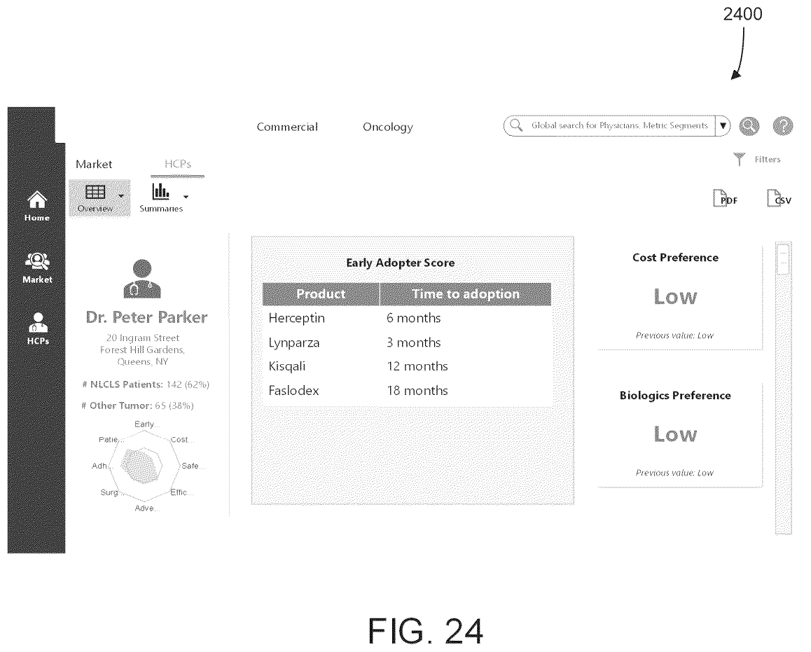

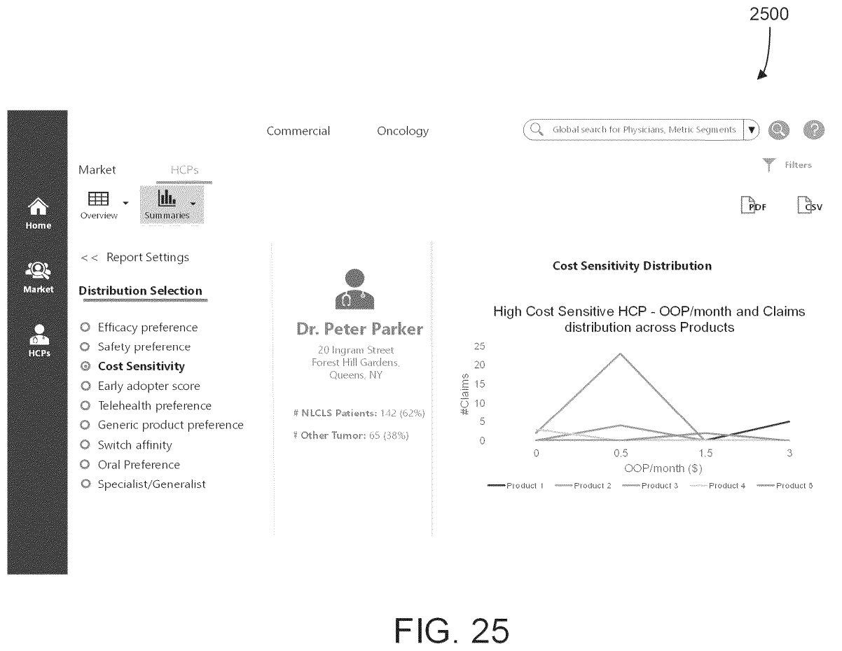

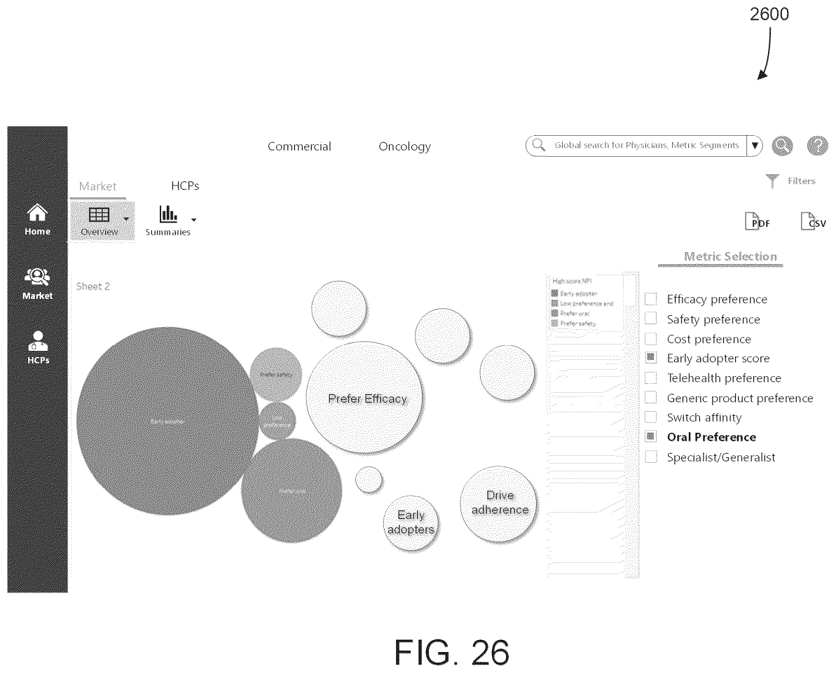

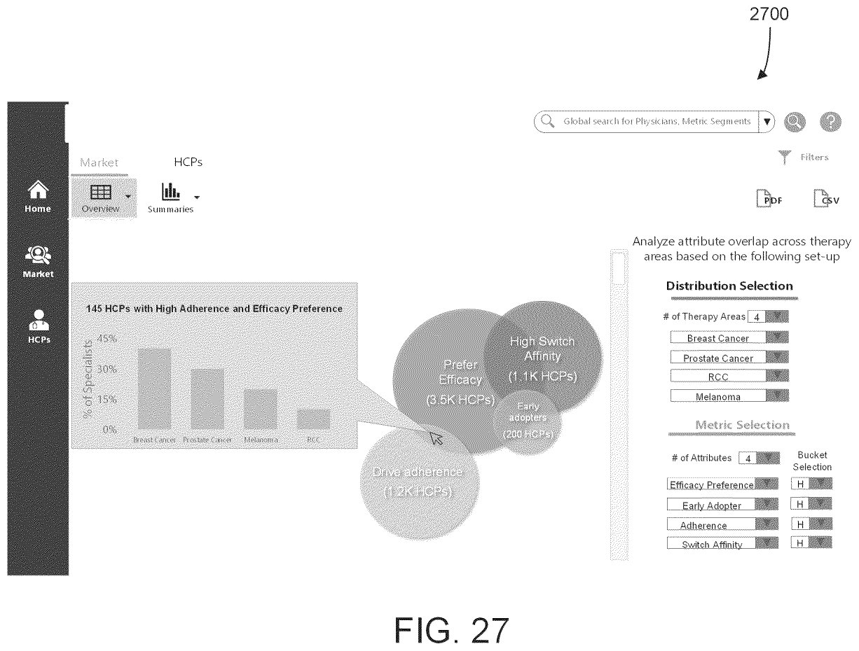

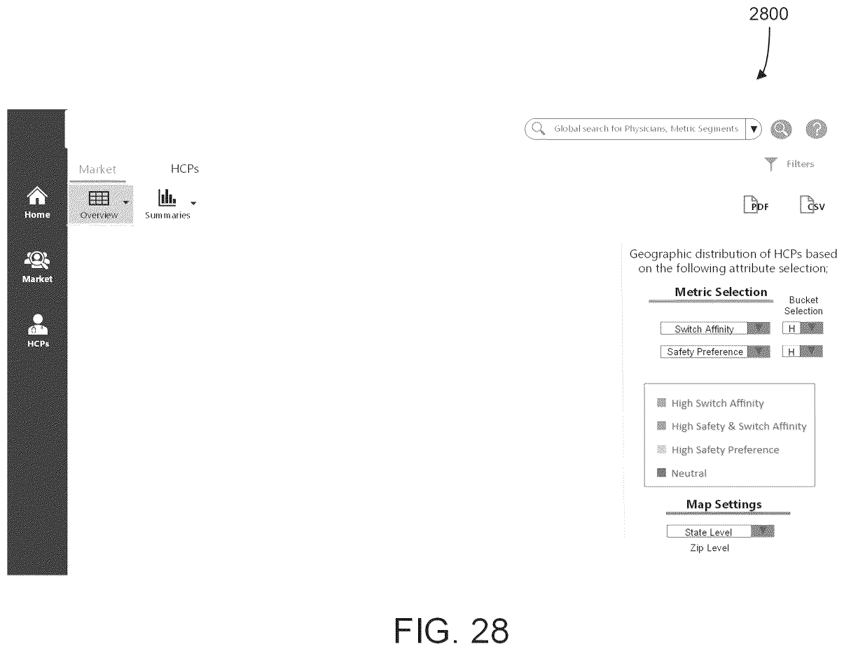

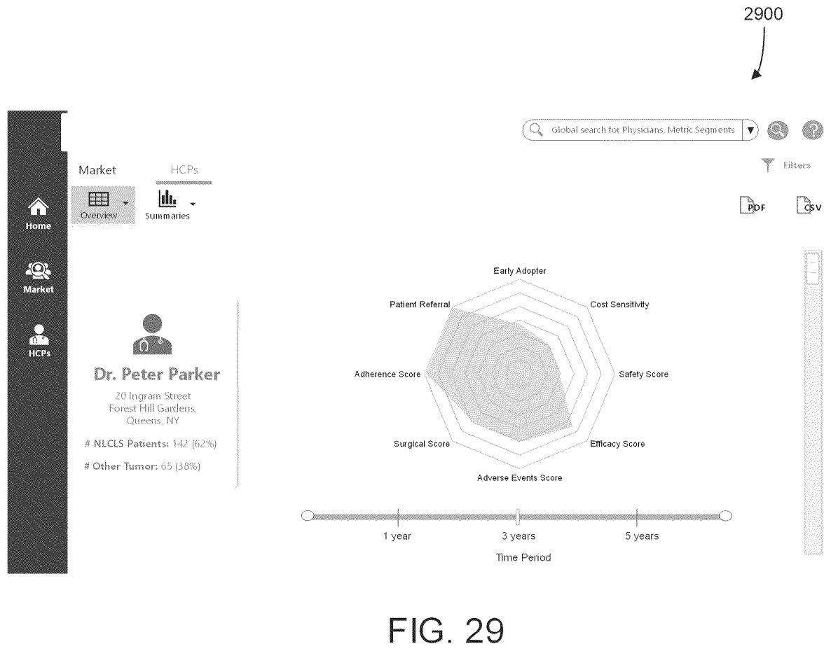

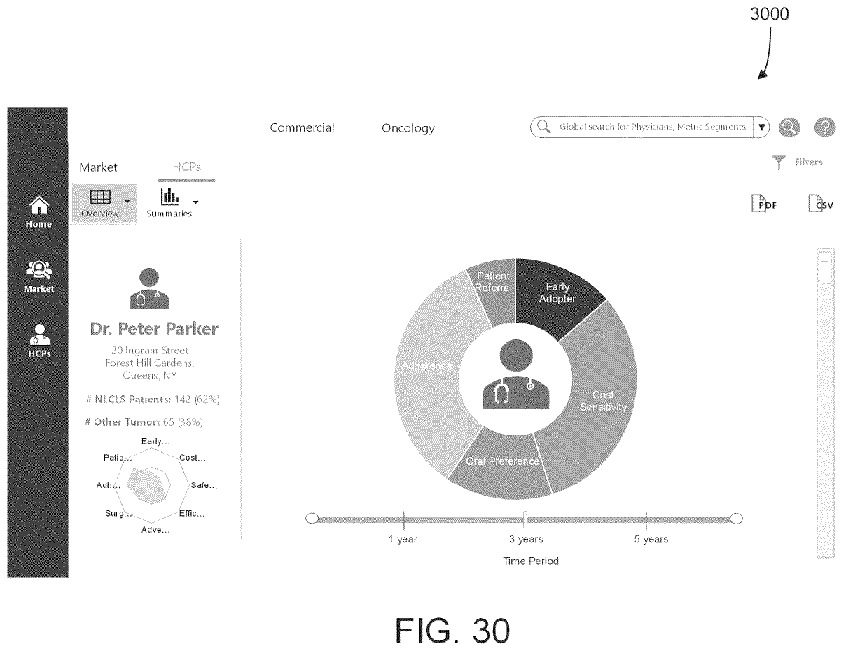

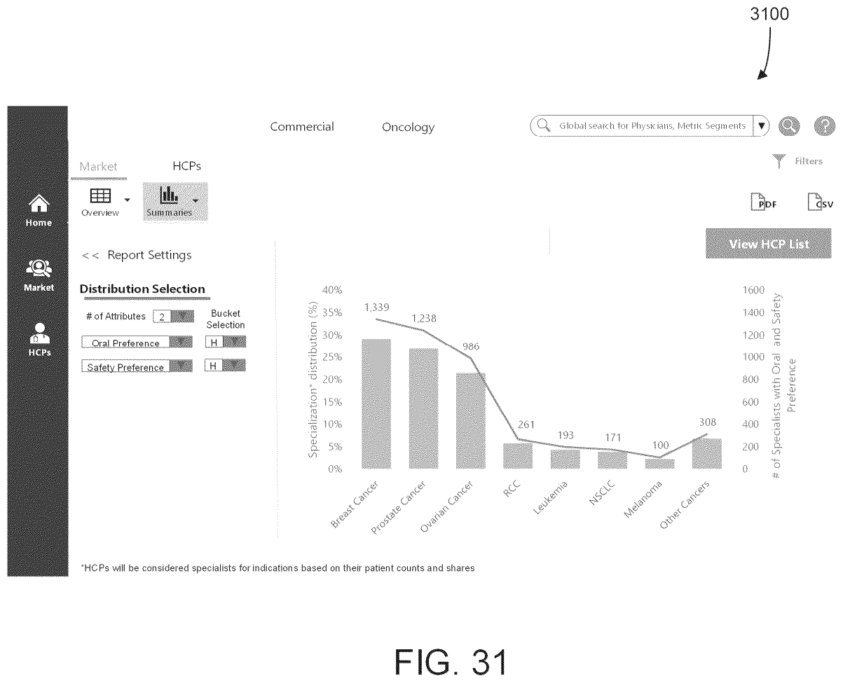

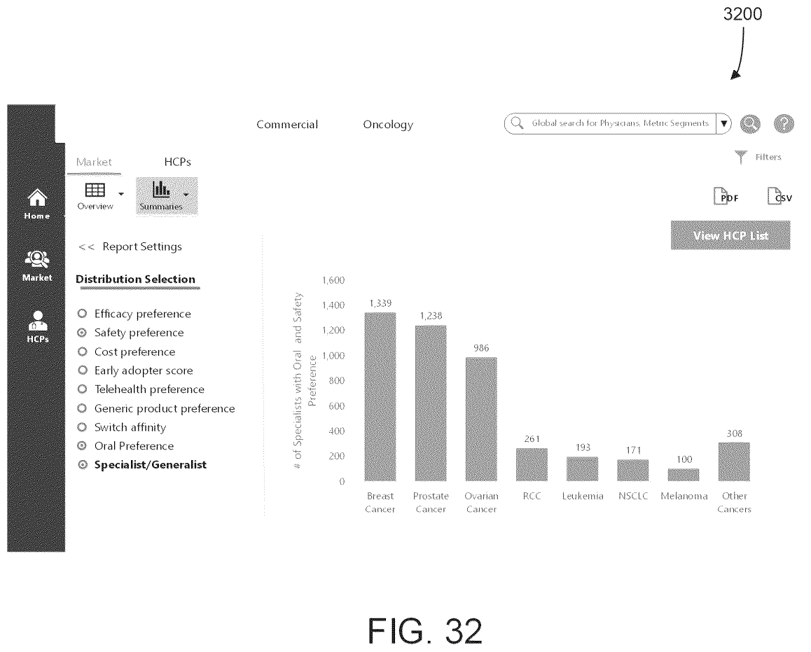

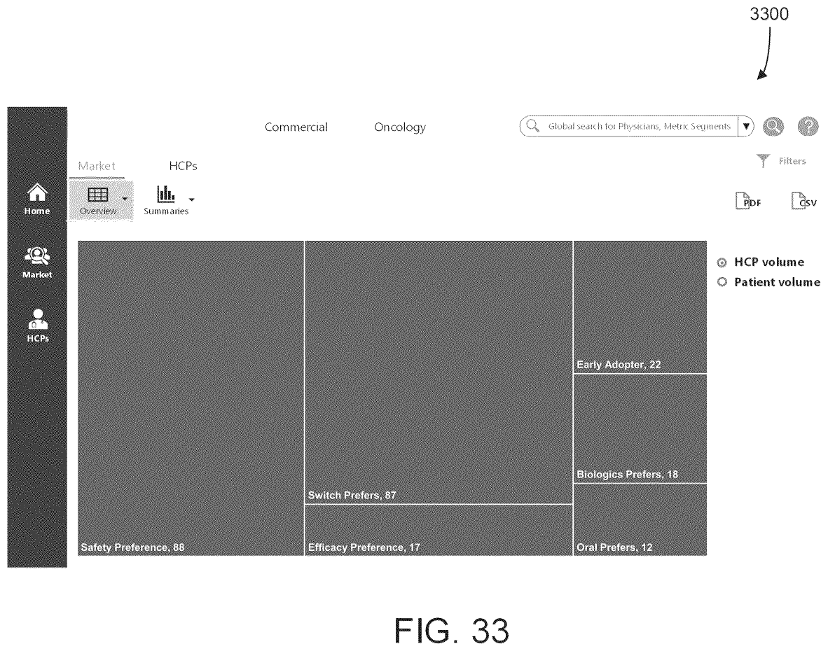

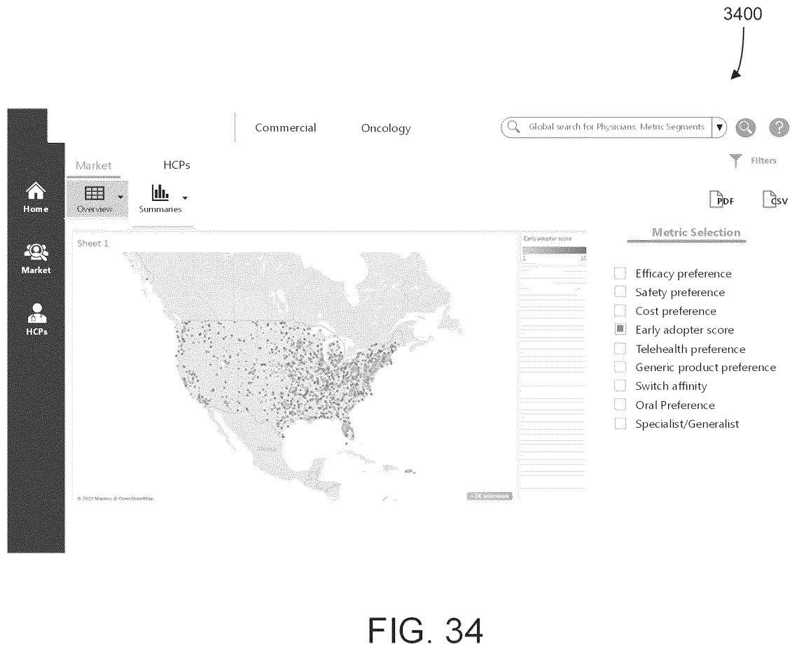

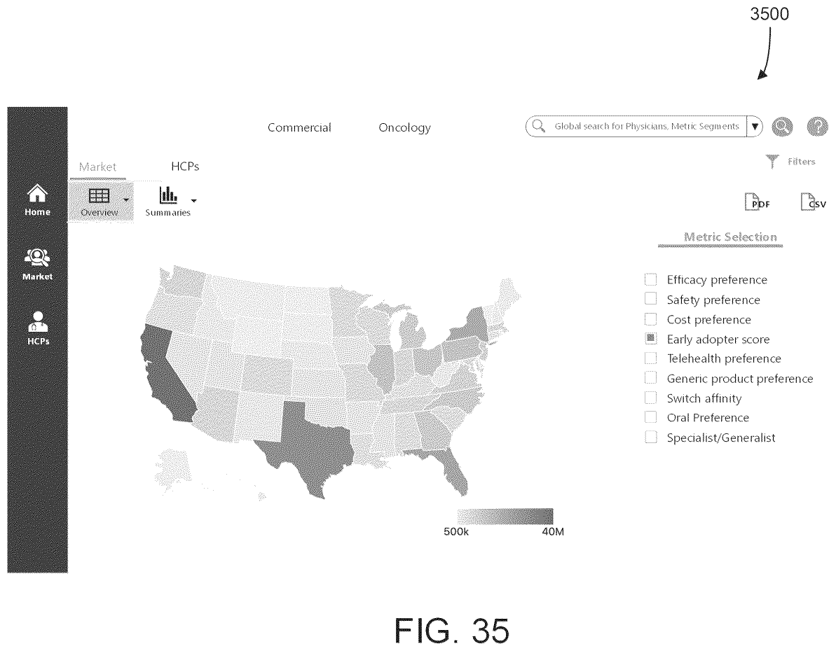

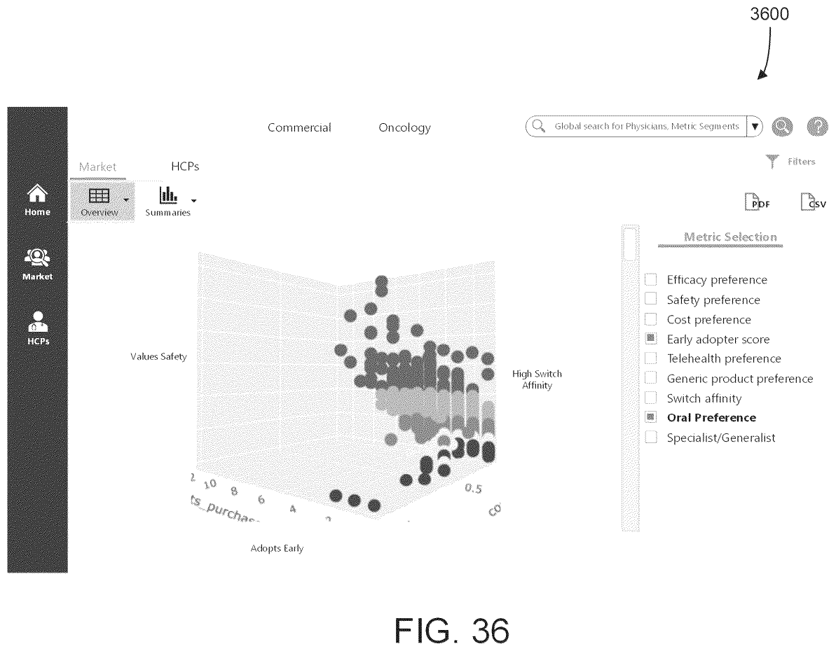

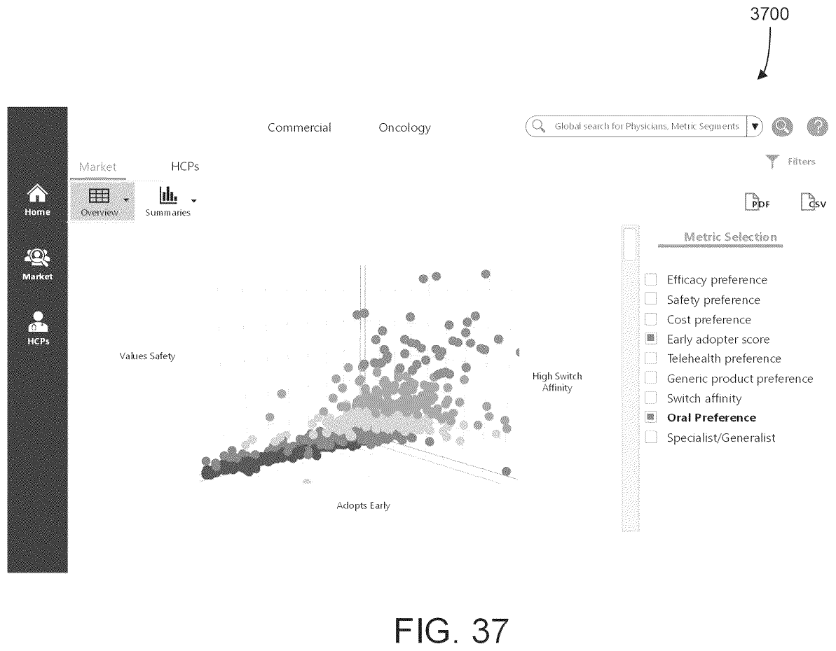

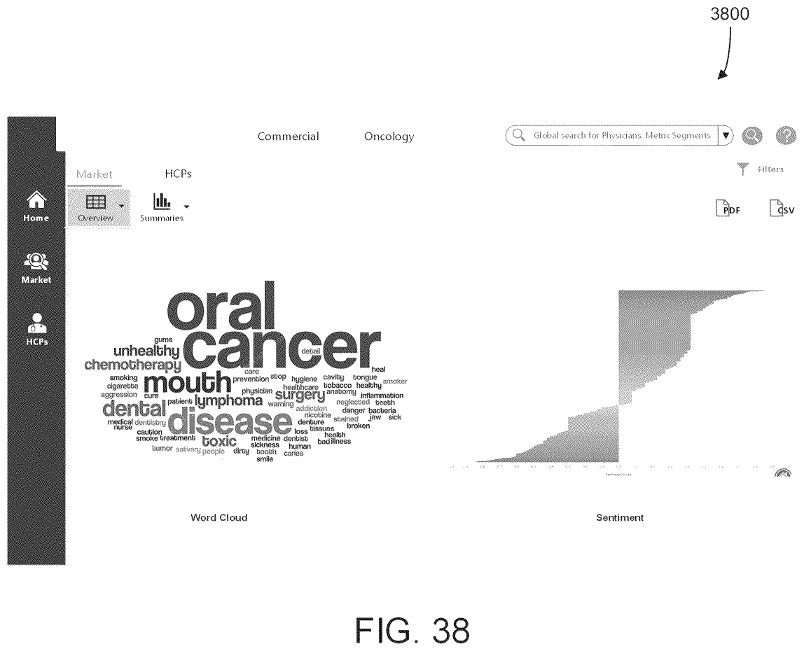

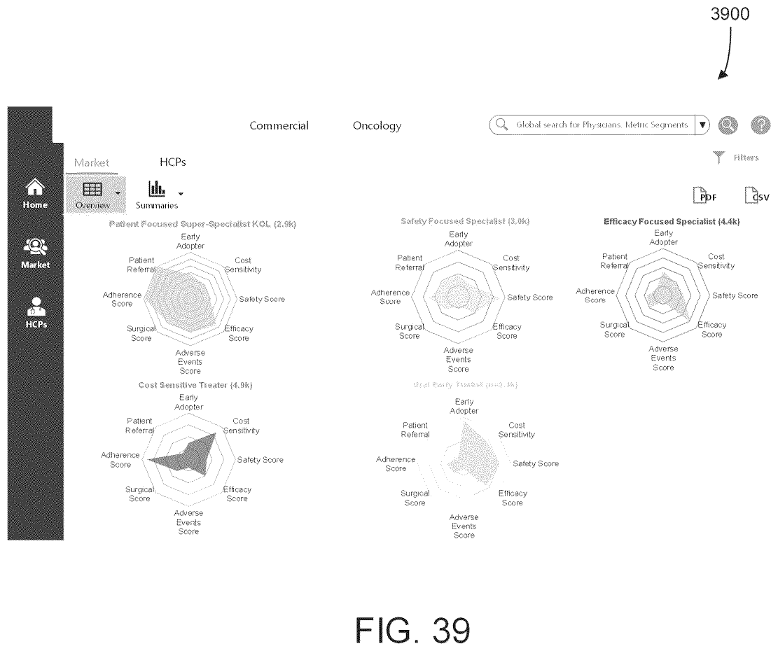

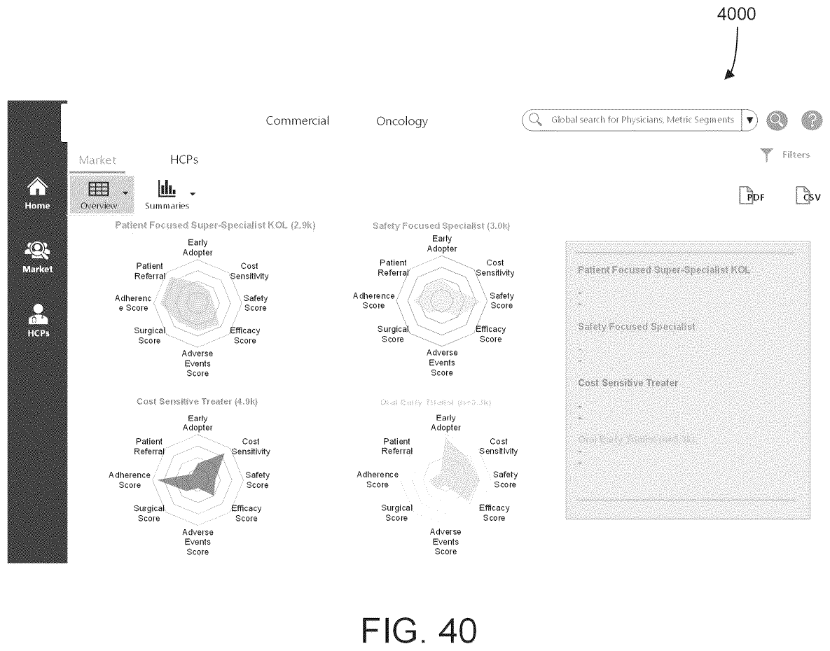

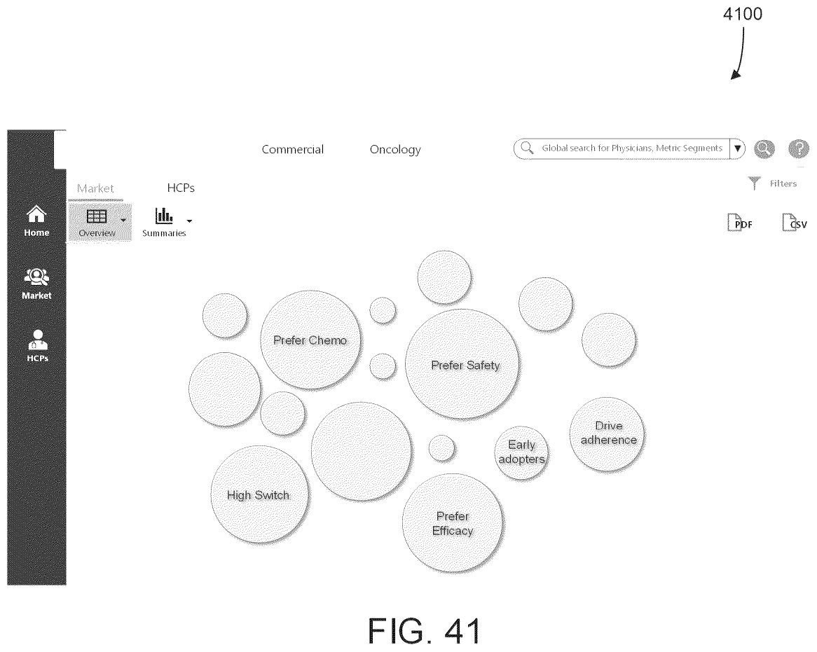

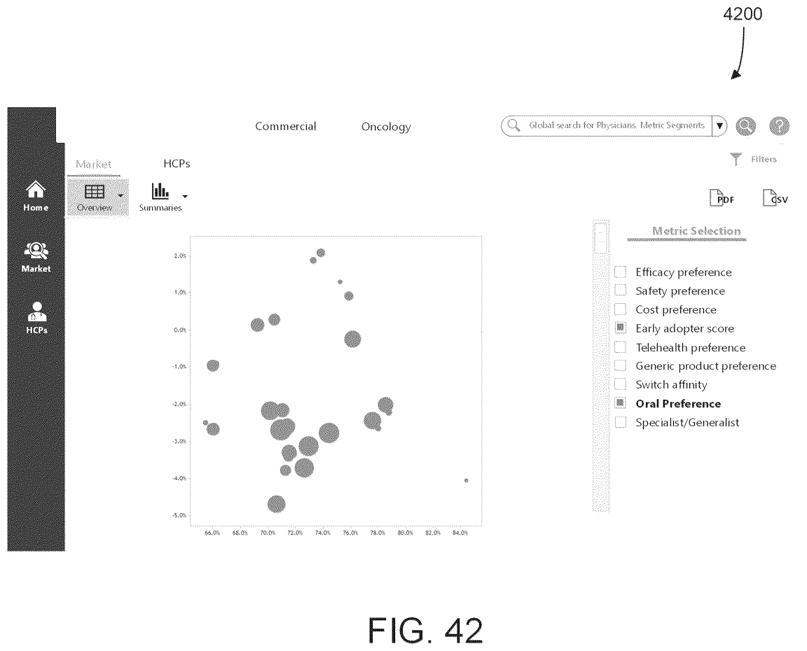

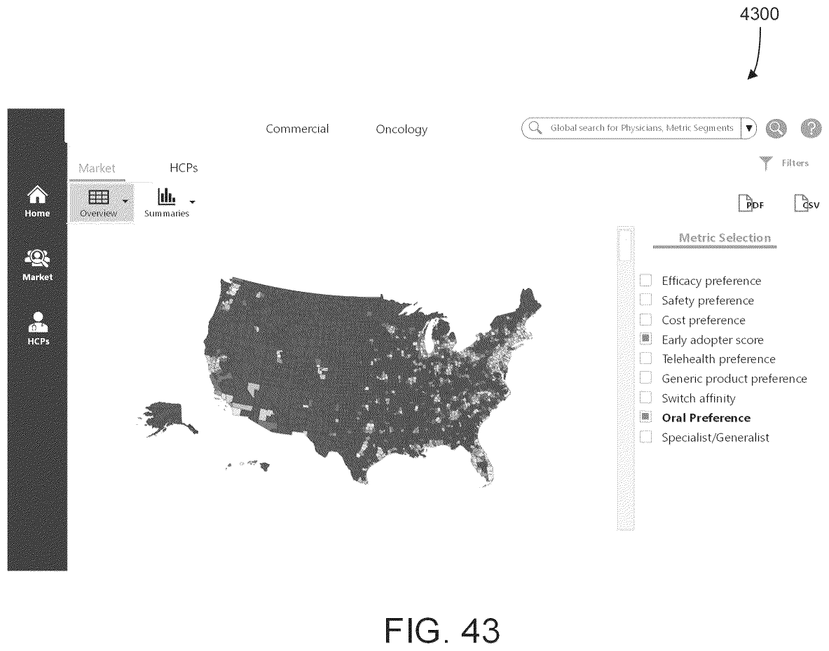

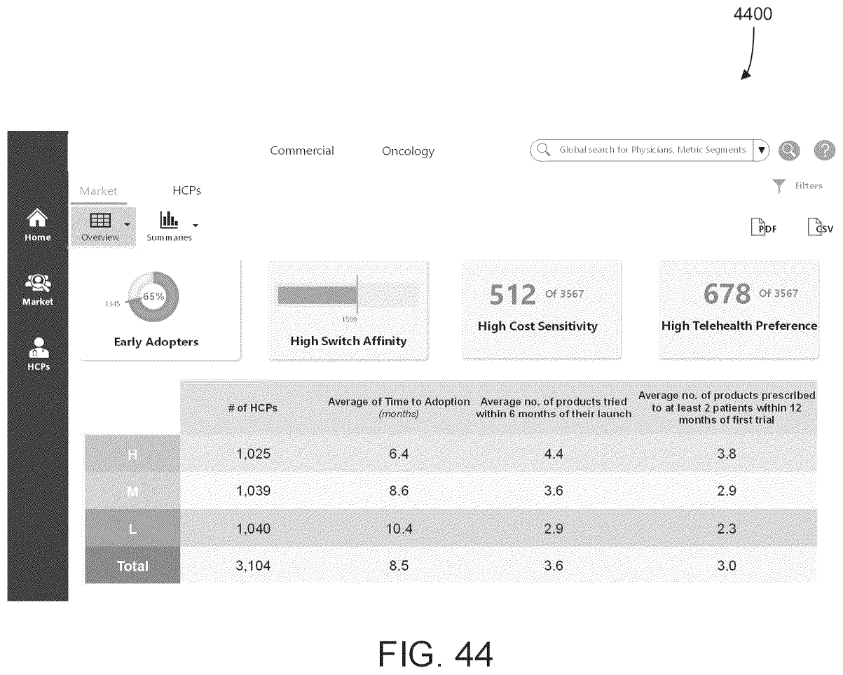

FIGS. 8-44 illustrate non-limiting examples of graphical user interfaces 800-4400 non-limiting examples of graphical user interfaces of an electronic platform enabling users to request and view details regarding medical personnel. A data processing system (e.g., the profile generation engine 202, the analytics server 310a, a client device 165, or any other computing device) may generate the user interfaces 800-4400 when providing users of a client device a platform.

The user interface 800 may include multiple statistics of medical personnel that have different traits, in some embodiments. Such traits may be determined by comparing metrics corresponding to the traits to a threshold (e.g., the same threshold or different thresholds for the different traits). The different traits may be early adopters, high switch affinity, high cost sensitivity, high telehealth preference, high safety preference, specialists, high adherence, and efficacy preference. As referred to herein, a score for a trait may be the metric or value for the trait. The data processing system may compare values for metrics that correspond to the traits and increment counters for the traits for each medical personnel that corresponds to a metric that satisfies the thresholds. The user interface 900 may provide options for a user to select to filter the data displayed at the user interface 800, in some embodiments. A user may select one of the selectable options (e.g., breast cancer, prostrate cancer, lung cancer, etc.) to filter or change the statistics to correspond to the selected option. For example, upon receiving a selection of breast cancer, the data processing system may update the user interface 800 or 900 to illustrate data of medical personnel that corresponds to lung cancer. For instance, the data processing system may update the graph shown for early adopters to show data for early adopters of lung cancer medical products. The data processing system may similarly filter each trait based on any number of selected options.

The data processing system may display data for different traits upon receiving a selection of a graphic for the traits. For example, the user interface 1000 illustrates an example user interface the data processing system may display upon receiving a selection of the early adopter trait at the user interface 800, in some embodiments. As illustrated, the data processing system may calculate data for “average time to adoption,” “number of products tried,” and “number of products adopted” from the clinical data stored in the medical personnel profiles and display the data at the user interface 1000. The user interface 1100 illustrates another embodiment of or variation of showing the data illustrated in the user interface 1000. The user interface 1200 illustrates another embodiment of presenting data for the early adopter trait. The user interface 1300 illustrates another embodiment of presenting data for the early adopter trait. The user interface 1400 illustrates another embodiment of presenting data for the early adopter trait. The user interface 1500 illustrates another embodiment of presenting data for the early adopter trait. The user interface 1600 illustrates data the data processing system presents upon receiving a selection of the high switch affinity trait, in some embodiments. The user interface 1700 illustrates data the data processing system presents upon receiving a selection of the high cost sensitivity trait, in some embodiments. The user interface 1800 illustrates data the data processing system presents upon receiving a selection of the efficacy preference trait, in some embodiments.

The user interfaces 1900-2200 illustrate summaries of medical personnel profiles stored by the data processing system, in some embodiments. The user interface 1900 illustrates a chart of medical personnel with the early adopter trait that have an oral preference trait. The early adopters may be rated on their level of being an early adopter (e.g., rated from N/A to 5). The data processing system may determine such levels for each early adopter by identifying scores the data processing system determines for the medical personnel and comparing the scores to the thresholds that correspond to the different levels. The data processing system may determine levels for the early adopters and counters for the chart that correspond to individual medical personnel with the corresponding levels. The data processing system may similarly determine levels of oral preference for the same medical personnel and increment the counters for the different sections of the chart that correspond to the levels of oral preference and early adopters. The data processing system may update the user interface 1900 to similarly include counters maintained and updated in the same manner for any number of traits. Such traits can be selected in the cross-tab selection section of the user interface 1900. The user interface 2000 may show a variation of the same data of the user interface 1900 but using percentage and levels of high, medium, and low for the early adopter and oral preference traits.

The user interface 2100 illustrates a bar graph of illustrating counts of counters of specialists for different medical fields or areas, in some embodiments. The data processing system may generate the user interface 2100 by incrementing and maintaining counters of medical personnel profiles that include flags for the different fields or areas indicating the medical personnel are specialists in the respective fields or areas. The user interface 2200 may illustrate a table of different medical personnel and ratings for the medical personnel the traits of efficacy, cost, and specialist.

The user interfaces 2300-2500 illustrate data of a medical personnel profile, in some embodiments. The user interface 2300 may include ratings of the medical personnel for different traits on a scale (e.g., high, medium, low) and other data regarding the medical personnel. The user interface 2400 may include early adopter scores for different medical products. The user interface 2500 may include cost sensitivities of the medical personnel for different medical products.

The user interfaces 2600-2800 illustrate data of medical personnel in different formats, in some embodiments. The user interface 2600 may include circle diagrams that illustrate the counts of counters of medical personnel associated with different traits. The circle diagrams may illustrate the counts based on the size of the circles. The user interface 2700 may illustrate a Venn diagram illustrating the overlap between medical personnel that have specific traits. A user may position a pointer within the diagram and the data processing system may present more fine-grained data (e.g., data regrading particular areas or fields). The user interface 2800 may illustrate an option to filter the data based on the geographic locations of the different medical personnel.

The user interfaces 2900-3000 illustrate diagrams of metrics of a medical personnel, in some embodiments. The data processing system may generate the user interface 2900 or the user interface 3000 by retrieving the metrics from a medical personnel profile of the medical personnel and display the respective user interfaces 2900 and 3000. In some cases, the data processing system may recalculate metrics for the medical personnel over time. The data processing system may store each recalculated metric in the profile with timestamps indicating the dates and/or times in which the metrics were recalculated. The data processing system may update the user interfaces 2900 and 3000 as a user moves a time bar to times for which the user wishes to see the metrics for the medical personnel, thus giving the user the ability to see changes in the medical personnel over time. In some cases, the data processing system may receive a request for an analysis for a particular time period via one of the user interfaces 2900 or 3000. The data processing system may receive the request and calculate an average or median for each of the traits based on the values that correspond to timestamps within the requested time period. The data processing system may update the user interfaces 2900 or 3000 according to the requested time period.

The user interfaces 3100 and 3200 may include distributions of medical personnel that are specialists in a particular field or area and/or and a safety preference according to a user selected level or “bucket” of the trait (e.g., high, medium, or low), in some embodiments. A user may select levels to use for different traits. The data processing system may retrieve scores or values from medical personnel profiles for the different traits and determine levels of the traits for the different medical personnel profiles. The data processing system may identify medical personnel that have scores or values in the selected levels. The data processing system may determine specialties of the identified medical personnel. The data processing system may do so by identifying counts and/or shares of patients with diseases in different areas (e.g., a medical personnel may be a specialist if the medical personnel treats a number of patient with a disease in the area or field above a threshold or a percentage of patients the medical personnel treats have a disease in the area or field above a threshold). The data processing system may identify the counts and/or shares by maintaining and incrementing counters for each medical personnel for different areas and/or fields. The data processing system may increment the counters for each patient the data processing system identifies the medical personnel as treating based on clinical data the data processing system receives for the patients. The data processing system may generate distributions according to the determined specializations, as illustrated in the user interfaces 3100 and 3200.

The user interfaces 3300-4400 may include graphical indicators of distributions of medical personnel according to the scores (e.g., metrics) or values of the medical personnel, in some embodiments. The data processing system may generate such distributions by retrieving scores for different metrics for different medical personnel and analyzing (e.g., comparing) the scores according to different thresholds. For example, the user interface 3300 may include a distribution chart illustrating counts of medical personnel that have scores exceeding a threshold for different metrics or traits. The user interface 3400 may include a map with dots overlaying a geographic location each indicating a different medical personnel and colored according to a score (e.g., an early adopter score) of the respective medical personnel. The user interface 3500 may include a map illustrating early adopter scores for medical personnel in sub-regions (e.g., states) of a region (e.g., the United States). The user interfaces 3600 and 3700 may include variations of a three dimensional chart with dots for individual medical personnel indicating the scores for the medical personnel for different metrics (e.g., values safety, high switch affinity, adopts early). The user interface 3800 may include a word cloud and/or a sentiment analysis for different medical personnel. The data processing system may generate the word cloud and/or sentiment analysis by retrieving data from medical personnel profiles stored in memory. The user interfaces 3900 and 4000 may illustrate type profiles for different medical personnel according to scores the data processing system calculates for the medical personnel. The data processing system may compare the scores to the type profiles to determine types for the medical personnel. The data processing system may store the types in the medical personnel profiles of the medical personnel.

The user interface 4100 may include a bubble diagram illustrating populations of medical personnel that have scores that exceed a threshold for different traits, in some embodiments. The user interface 4200 may include a bubble graph illustrating populations of medical personnel that have scores that are within different ranges for multiple traits (e.g., selected traits), in some embodiments. The user interface 4300 may include a map of a geographic region with sub-regions color to indicate sub-regions with high and low numbers of medical personnel with scores for traits that exceed a threshold and/or average scores of different traits (e.g., selected traits), in some embodiments. The user interface 4400 illustrates a summary of the number of early adopters in different levels and values indicating statistics for the early adopters in each level, in some embodiments.

Advantageously, a user accessing a platform may view and interact with the different user interfaces illustrated in FIGS. 8-44 to view different data about medical personnel. The user may filter the data to view medical personnel with different criteria and according to different geographical areas to view the performance profiles of the medical personnel. The data can be specific to a health care provider and/or for multiple healthcare providers. The data can help a health care provider determine performance of the health care provider's facilities and determine ways to improve the performance. The platform can help health care providers select medical personnel for different tasks.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What we claim is:

1. A method, comprising:
receiving, by a processor from a plurality of data sources, clinical data for a plurality of medical personnel, the clinical data identifying a timing of one or more prescriptions of each of the plurality of medical personnel relative to a launch of a type of medical product;
training, by the processor, using machine learning applied to the clinical data, a model configured to receive as input clinical data of a medical personnel and a type of medical product and provide as output a score identifying a likelihood of the medical personnel to prescribe a medical product of the type of medical product within a defined time period relative to a launch of the medical product;
providing, by the processor, clinical data of a first medical personnel and a first type of medical product to the model;
receiving, by the processor from the model, a score indicating a likelihood of the first medical personnel to prescribe the first type of medical product within the defined time period relative to a launch of the first type of medical product; and
causing, by the processor, a display at a client device based on the score.

2. The method of claim 1, comprising:
determining, by the processor, whether the score exceeds a threshold,
wherein the causing the display based on the score is based on the determining as to whether the score exceeds the threshold.

3. The method of claim 1, comprising:
providing, by the processor, clinical data of a plurality of medical personnel and the first type of medical product to the model, the plurality of medical personnel comprising the first medical personnel;
receiving, by the processor, a score for each of the plurality of medical personnel;
ranking, by the processor, the plurality of medical personnel according to the scores; and
selecting, by the processor, the first medical personnel for the display based on the rankings.

4. The method of claim 3, comprising:
receiving, by the processor, a request from a client device, the request comprising the first type of medical product,
wherein providing the clinical data of the plurality of medical personnel to the model is performed in response to receipt of the request, and
wherein causing the display at the client device comprises displaying the first medical personnel on a user interface at the client device.

5. The method of claim 1, comprising:
executing, by the processor, a plurality of models using the clinical data of the first medical personnel as input into each of the plurality of models to obtain a plurality of metrics; and
generating, by the processor, a profile for the first medical personnel in memory by inserting the score and the plurality of metrics into the profile.

6. The method of claim 5, wherein generating the profile for the first medical personnel comprises inserting, by the processor, the score and the plurality of metrics into separate cells of a table.

7. The method of claim 5, wherein causing the display at the client device comprises causing, by the processor, the display based on the score and the plurality of metrics at the client device.

8. The method of claim 5, comprising:
executing, by the processor, a model trained to generate composite scores for medical personnel, using each of the plurality of metrics and the score as input to obtain a composite score for the first medical personnel,
wherein causing the display at the client device comprises causing, by the processor, the display based on the composite score.

9. The method of claim 8, comprising:
comparing, by the processor, the composite score to a threshold,
wherein causing the display at the client device comprises causing, by the processor, the display based on the comparing the composite score to the threshold.

10. The method of claim 1, comprising:
executing, by the processor, the model using the clinical data of the first medical personnel as input to the model to output the score.

11. A system comprising a server comprising a processor and a non-transitory computer-readable medium containing instructions that when executed by the processor causes the processor to perform operations comprising:
receiving, from a plurality of data sources, clinical data for a plurality of medical personnel, the clinical data identifying a timing of one or more prescriptions of each of the plurality of medical personnel relative to a launch of a type of medical product;
training using machine learning applied to the clinical data, a model configured to receive as input clinical data of a medical personnel and a type of medical product and provide as output a score identifying a likelihood of the medical personnel to prescribe a medical product of the type of medical product within a defined time period relative to a launch of the medical product;
providing clinical data of a first medical personnel and a first type of medical product to the model;
receiving, from the model, a score indicating a likelihood of the first medical personnel to prescribe the first type of medical product within the defined time period relative to a launch of the first type of medical product; and
causing a display at a client device based on the score.

12. The system of claim 11, the operations comprising:
determining whether the score exceeds a threshold,
wherein the causing the display based on the score is based on the determining whether the score exceeds the threshold.

13. The system of claim 11, the operations comprising:
providing clinical data of a plurality of medical personnel to the model, the plurality of medical personnel comprising the first medical personnel;
receiving a score for each of the plurality of medical personnel;
ranking the plurality of medical personnel according to the scores; and
selecting the first medical personnel for the display based on the rankings.

14. The system of claim 13, comprising:
receiving, by the processor, a request from the client device, the request comprising the type of medical product,
wherein providing the clinical data of the plurality of medical personnel to the model is performed in response to receipt of the request, and
wherein causing the display at the client device comprises displaying the first medical personnel on a user interface at the client device.

15. A method for training a model for medical product early adopter prediction, comprising:
receiving, by a processor and from a plurality of data sources, clinical data for a plurality of medical personnel, the clinical data identifying a timing of one or more prescriptions of each of the plurality of medical personnel relative to a launch of a medical product;
identifying, by the processor and from the clinical data, a timestamp of the launch of the medical product and a timestamp of each of the one or more prescriptions for the medical product by each of the plurality of medical personnel;
determining, by the processor, one or more differences between the timestamp of the launch of the medical product and one or more timestamps of the one or more prescriptions;
generating, by the processor, a training data set according to the one or more differences; and
training, by the processor, the model with the training data set using machine learning.

16. The method of claim 15, wherein generating the training data set comprises generating, by the processor, a training data set by, for each of the plurality of medical personnel:
generating, by the processor, a feature vector for the medical personnel, the feature vector comprising clinical data regarding the medical personnel; and
labeling, by the processor, the feature vector according to at least one of the one or more differences associated with the medical personnel.

17. The method of claim 16, comprising:
identifying, by the processor, a plurality of differences between timestamps of a plurality of launches of medical products and timestamps of a plurality of prescriptions of the plurality of medical personnel for a plurality of medical products of a first product type; and
determining, by the processor, a first value as a function of the plurality of differences,
wherein labeling the feature vector according to the one or more of the plurality of differences comprises labeling the feature vector according to the first value.

18. The method of claim 17, wherein determining the first value comprises determining, by the processor, an average or a median of the plurality of differences.

19. The method of claim 17, comprising:
determining, by the processor, whether the first value exceeds a threshold,
wherein labeling the feature vector according to the one or more of the plurality of differences comprises labeling, by the processor, the feature vector according to the determining of whether the first value exceeds the threshold.

20. The method of claim 16, wherein generating the feature vector comprises inserting a type of the medical product into the feature vector.
